(19) United States
(12) Patent Application Publication
(10) Pub. No.: US 2026/0102742 A1
(43) Pub. Date: Apr. 16, 2026

(54) MULTI-SCALED CELLULOSIC NETWORKS

(71) Applicant: Khalifa University of Science and Technology, Abu Dhabi (AE)

(72) Inventors: Blaise L. TARDY, Abu Dhabi (AE); Mano GOVINDHARAJ, Abu Dhabi (AE); Charalampos PITSALIDIS, Abu Dhabi (AE); Anna Maria PAPPA, Abu Dhabi (AE); Srinivas METTU, Abu Dhabi (AE)

(21) Appl. No.: 18/933,184

(22) Filed: Oct. 31, 2024

(30) Foreign Application Priority Data
Oct. 15, 2024 (EP) 24386118.4

(51) Int. Cl. B01D 71/10; B01D 61/14; C02F 1/44; C08B 1/08

(52) U.S. Cl. CPC B01D 71/10; B01D 61/147; C02F 1/444; C08B 1/08; C02F 2303/04

(57) ABSTRACT

A method for preparing a cellulose nanonetwork includes (a) contacting an alkaline liquid with tunicate material sufficient to form an at least partially deproteinized material; and (b) contacting the at least partially deproteinized material with a bleaching liquid sufficient to remove one or more non-cellulose materials and to prepare a product material.

### CROSS-REFERENCE TO RELATED APPLICATIONS

This application claims priority to European Patent Application No. 24386118.4, titled “MULTI-SCALED CELLULOSIC NETWORKS”, filed Oct. 15, 2024, the contents of which are incorporated by reference herein.

### TECHNICAL FIELD

The subject matter disclosed herein relates generally to cellulose-containing materials and more particularly to structures of cellulosic nanonetworks. The present disclosure further relates to methods for forming such structures of cellulosic nanonetworks.

### BACKGROUND

The bioeconomy is a global endeavor that connects biomass generation and its management towards the supply of resources required for a circular economy. The bioeconomy can include using biological resources from land and sea to produce food, materials, and energy. In recent years, a wider range of streams including nanocellulosics have been identified for their transformative potential. Biosynthesized nanonetworks can be obtained via microbial growth of cellulose. For example, microbially grown nanonetworks can follow guided growth via chemotaxis, wherein three-dimensional (3D) features at the scale of 100-300 μm can be obtained in the wet-state. Wood or plants in general can be used as sources for cellulose, and these wood and plant sources contain non-cellulosics. The removal of non-cellulosics can be energy- and reagents-intensive, and the presence of lignin and hemicelluloses can affect the efficiency of non-cellulosics removal. To further improve the bioeconomy, it is desirable to provide additional processes and new cellulosic nanonetwork-containing structures to widen the scope of materials obtained from cellulose-containing resources. It is further desirable to efficiently form these cellulosic nanonetwork-containing structures using sources that may contribute to local and global ecosystems. For example, if considering coastal biomass, it is desirable to provide improved biodiversity.

### SUMMARY

According to one aspect, a method for preparing a cellulose nanonetwork includes (a) contacting an alkaline liquid with tunicate material sufficient to form an at least partially deproteinized material; and (b) contacting the at least partially deproteinized material with a bleaching liquid sufficient to remove one or more non-cellulose materials and to prepare a product material.

According to another aspect, a cellulose-containing material includes a 3-dimensional structure including: cellulose nanofibers; and a plurality of channels, the plurality of channels including first channels and second channels, wherein the first channels exhibit a first mean diameter of between 10 μm and 80 μm, and the second channels exhibit a second mean diameter greater than the first mean diameter, wherein the 3-dimensional structure is substantially free of proteins.

According to another aspect, a microfiltration membrane includes cellulose fibers; and a plurality of channels, the plurality of channels including first channels and second channels, wherein the first channels exhibit a first mean diameter of between 10 μm and 80 μm, and the second channels exhibit a second mean diameter greater than the first mean diameter, wherein at least a portion of the cellulose fibers exhibit an entangled orientation.

According to another aspect, a method for membrane filtration includes transferring a liquid through at least a portion of a structure sufficient to remove at least a portion of one or more substances from the liquid.

According to another aspect, a microfluidics perfusion material includes cellulose-containing materials of the present disclosure, wherein the microfluidics perfusion material is sufficient for perfusion of a liquid into a plurality of channels.

According to another aspect, a method for recellularization includes introducing a fibroblast-containing liquid within a structure and introducing media within the structure.

### BRIEF DESCRIPTION OF THE DRAWINGS

FIG. 1 illustrates a method for preparing a cellulose network, according to some embodiments.

FIG. 2A illustrates a side view of a 3-Dimensional structure including cellulose, with an enlarged image, according to some embodiments.

FIG. 2B illustrates a cross-sectional view of a vessel of the present disclosure, according to some embodiments.

FIG. 2C illustrates a method for membrane filtration, according to some embodiments.

FIG. 2D illustrates a method for recellularization, according to some embodiments.

FIG. 3A illustrates a microscopic image of one region displaying a branched vascular network in raw tunicates, according to some embodiments.

FIG. 3B illustrates a microscopic image of one region displaying a branched vascular network in raw tunicates, according to some embodiments.

FIG. 3C illustrates a microscopic image of one region displaying a branched vascular network in raw tunicates, according to some embodiments.

FIG. 3D illustrates vascular analysis with means and standard deviation values for the region illustrated in FIG. 3A.

FIG. 3E illustrates vascular analysis with means and standard deviation values for the region illustrated in FIG. 3B.

FIG. 3F illustrates vascular analysis with means and standard deviation values for the region illustrated in FIG. 3C.

FIG. 3G illustrates a scanning electron microscope (SEM) image of a portion of a processed tunicate, according to some embodiments.

FIG. 3H illustrates a polarized light microscopic image of a portion of a raw tunicate, according to some embodiments.

FIG. 3I illustrates a polarized light microscopic image of a portion of a raw tunicate, according to some embodiments.

FIG. 4A illustrates a histogram illustrating the average diameter measurements in the region of FIG. 3A, according to some embodiments.

FIG. 4B illustrates a histogram illustrating the average diameter measurements in the region of FIG. 3B, according to some embodiments.

FIG. 4C illustrates a histogram illustrating the average diameter measurements in the region of FIG. 3C, according to some embodiments.

FIG. 5 illustrates an example method for preparing a cellulose network, according to some embodiments.

FIG. 6A illustrates an SEM image of the raw tunicate, including protein-cellulose complex, nanofibers, and cells, according to some embodiments.

FIG. 6B illustrates an SEM image of the product material after deproteinization, according to some embodiments.

FIG. 6C illustrates an SEM image of the product material after bleaching, according to some embodiments.

FIG. 7 illustrates a histogram showing the width distribution of cellulose fibers in the product material, according to some embodiments.

FIG. 8A illustrates an SEM image of a portion of a raw tunicate, according to some embodiments.

FIG. 8B illustrates an SEM image of a portion of a deproteinized tunicate, according to some embodiments.

FIG. 8C illustrates an SEM image of a portion of a product material, according to some embodiments.

FIG. 9 illustrates ultraviolet-visible (UV-Vis) spectra comparing raw tunicate, deproteinized tunicate, and product material (substantially pure cellulosic nanonetwork), according to some embodiments.

FIG. 10A illustrates Fourier Transform Infrared Spectroscopy (FTIR) analysis of raw tunicate, deproteinized tunicate, and product material, according to some embodiments.

FIG. 10B illustrates x-ray crystallography (XRD) analysis showing the presence of cellulose nanofibers in raw tunicate, deproteinized tunicate, and product material, according to some embodiments.

FIG. 11 illustrates the water uptake efficiency of raw tunicate, deproteinized tunicate, and product material, according to some embodiments.

FIG. 12A illustrates tensile stress-strain response of wet samples, according to some embodiments.

FIG. 12B illustrates strain at failure (ductility) of various samples, according to some embodiments.

FIG. 12C illustrates tensile stress at failure (ultimate tensile strength) of various samples in the wet state, according to some embodiments.

FIG. 12D illustrates tensile stress at failure (ultimate tensile strength) of various samples in the dry state, according to some embodiments.

FIG. 12E illustrates elastic modulus of various samples in the wet state, according to some embodiments.

FIG. 12F illustrates elastic modulus of various samples in the dry state, according to some embodiments.

FIG. 13A illustrates compression stress-strain curves of product material from the top region, according to some embodiments.

FIG. 13B illustrates e-modulus for raw tissue from (Raw-B), middle (Raw-M), top (Raw-T), and low-vein regions (Raw-LV), according to some embodiments.

FIG. 13C illustrates e-modulus for deproteinized product from the middle region (DP-B), middle (DP-M), Top (DP-T), and low vein regions (DP-LV), according to some embodiments.

FIG. 13D illustrates e-modulus for product material from the bottom region (Nano-B), middle (Nano-M), Top (Nano-T), and low vein regions (Nano-LV), according to some embodiments.

FIG. 14A illustrates toughness performance for Raw (Raw), Deproteinized (DP), and product (Nano) materials in the Bottom (B), Middle (M), Top (T), and Low-Vein (LV) regions, according to some embodiments.

FIG. 14B illustrates ultimate compressive strength for Raw (Raw), Deproteinized (DP), and product (Nano) materials in the Bottom (B), Middle (M), Top (T), and Low-Vein (LV) regions, according to some embodiments.

FIG. 15A illustrates perfusion through product material, according to some embodiments.

FIG. 15B illustrates perfusion through product material, according to some embodiments.

FIG. 15C illustrates perfusion through product material, according to some embodiments.

FIG. 15D illustrates perfusion through product material, according to some embodiments.

FIG. 16 illustrates perfusion distance of methylene blue through the product material at constant applied fluid pressure, according to some embodiments.

FIG. 17 illustrates UV analysis for the extraction of bioink at various temperatures, according to some embodiments.

FIG. 18 illustrates a comparison of the reactivity based on protein chemistry of a tunicate and the product material of the present disclosure, according to some embodiments.

FIG. 19A illustrates water vapor permeability (WVP) of raw tunicate, deproteinized tunicate, and product material, according to some embodiments.

FIG. 19B illustrates water vapor transmission rate (WVTR) of raw tunicate, deproteinized tunicate, and product material, according to some embodiments.

FIG. 20A illustrates UV-Vis analysis of bacterial solutions before and after filtration, according to some embodiments.

FIG. 20B illustrates an SEM image showing bacteria on a membrane after filtration, according to some embodiments.

FIG. 20C illustrates near zero bacterial growth in the solution post-filtration after overnight culture of the filtrate, according to some embodiments.

FIG. 20D illustrates the observation of bacterial growth after overnight culturing prior to filtration, according to some embodiments.

FIG. 21 illustrates an example method for recellularization, according to some embodiments.

FIG. 22A illustrates a fluorescence image following perfusion, according to some embodiments.

FIG. 22B illustrates an enlarged view of a portion of FIG. 22A, according to some embodiments.

FIG. 22C illustrates a fluorescence image showing liquid bubbles, according to some embodiments.

FIG. 22D illustrates a fluorescence image showing liquid bubbles, according to some embodiments.

FIG. 22E illustrates a fluorescence image showing y-shaped channels and a network of microfluidics, according to some embodiments.

FIG. 22F illustrates a fluorescence image showing cell attachment, growth and proliferation along microvasculature, according to some embodiments.

FIG. 23A illustrates a control image showing vasculature without cells, according to some embodiments.

FIG. 23B illustrates an imaging showing that recellularized structures preserve patency and perfusion capabilities after bleaching, according to some embodiments.

FIG. 23C illustrates 4′,6-diamidino-2-phenylindole (DAPI) staining showing the presence of fibroblast cells on the structure, according to some embodiments.

FIG. 23D illustrates fractures in the vascular channels with cell accumulation at these sites, according to some embodiments.

FIG. 23E illustrates healthy cell attachment and proliferation, with cells growing near the main channel, first-order branches, and network areas after three days, according to some embodiments.

FIG. 23F illustrates an enlarged view of a portion of FIG. 23E, according to some embodiments.

### DETAILED DESCRIPTION

Embodiments of the present disclosure provide novel cellulose-containing materials and methods of forming these cellulose-containing materials. These cellulose-containing materials can be prepared using abundantly available marine materials and an efficient treatment method. For example, the cellulose-containing materials can be prepared from one or more portions of a tunicate. Cellulose-containing materials of the present disclosure can include a structure having a cellulose network (e.g., cellulose nanonetwork)—useful for various applications such as membrane filtration, microfluidics, and recellularization. Further, the materials of the present disclosure can be used for sensing, controlled drug release, and implant applications.

Tunicates (some may be referred to as “ascidians”) are widely available in most coastal regions and can be found as native species that promote a healthy ecosystem or as invasive marine bio-foulants. Tunicates can be referred to as “sea squirts”. For example, in the Gulf region, native tunicates such as Phallusia nigra grow year-round at a high rate due to the consistently high sea temperatures. Tunicates can attach themselves to various structures, such as the hull of a ship, docks, and rocks. Importantly, tunicates can be a source of cellulose that is synthesized by animal cells. For example, tunicates can be a source of cellulose that is the only source synthesized by animal cells. Therefore, these tunicates represent a favorable source of biomass to be converted to high-end materials. Accordingly, providing sustainable processing of tunicates into advanced materials is important for the management of invasive tunicates.

Tunicate materials include one or more materials, such as cellulose-containing materials, from a tunicate. The cellulose-containing material can include tissue from at least a portion of the outer tunic, or exoskeleton, of the tunicate. Since the cellulose-containing material can include tissue from at least a portion of the outer tunic, the tunicate materials can include at least one of cells, blood vessels, and proteins. Tunicates include marine invertebrate animals and are generally members of the subphylum Tunicata. Importantly, tunicates can be considered invasive species in certain areas of the world, and utilizing invasive species for enhanced materials can further improve the bioeconomy by remedying to the local contamination and valorizing it.

The tunicate can include an invasive marine species. In one example, the tunicate includes one or more species in the Ascidiacea class. In another example, the tunicate includes one or more species in the Ascidiidae family. The Ascidiidae family can include a genus selected from Ascidia, Ascidiella, Phallusia, Botryllus, and Psammascidia. Examples of species in the Ascidia genus include Ascidia caudata, Ascidia incrassata, and Ascidia mentula. An example of a species in the Ascidiella genus is Ascidiella aspersa. Examples of species in the Phallusia genus include Phallusia fumigata, Phallusia mammillata, Phallusia nigra. Other species within the genera Ascidia, Ascidiella, Phallusia, and Psammascidia are intended to be within the scope of the present disclosure. An example species in the Botryllus genus is Botryllus schlosseri.

Tunicates of the present disclosure can exhibit a unique vasculature and pore structures. For example, the natural structure of the tunicate (e.g., Phallusia nigra) facilitates the transport of nutrients through microvasculature. The tunicates may exhibit a multimodal capillary size, where size distributions can include multiple distinct scales. For example, the capillary system can include: large capillaries at or above 500 μm, and three sub-types of branches categorized as arteries (e.g., diameter: 280-650 μm), macro-capillaries (e.g., diameter: 120-240 μm), and capillaries (e.g., diameter: 50-100 μm). These micro vasculatures are contained within the cellulose nanofiber construct, encircled by rounded hollow cells, where the cellulose can be part of the extracellular matrix surrounding and connecting individual cells that are themselves encapsulated in a single sheet layer of nanocellulose. In one example, the vasculature and pore structure for cellulosic exoskeletons of tunicates is different from plants, since plant vasculature exists across plant fibers.

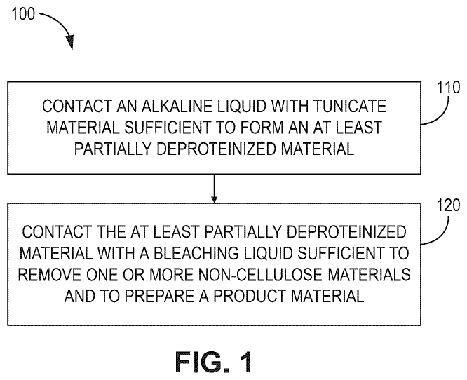

FIG. 1 illustrates method 100 for preparing a cellulose nanonetwork, according to some embodiments. Method 100 can include at least one of the following steps:

Referring to Step 110, an alkaline liquid is contacted with tunicate material sufficient to form an at least partially deproteinized material. The tunicate material includes tunicate materials of the present disclosure, such as the tunic tissue from a tunicate. The tunicate material can include pigments and an extracellular matrix densely packed with protein-cellulose fibril aggregates. In one example, upon contacting, the alkaline liquid is capable of generating hydroxyl (HO·) and superoxide anion (O2·−) radicals, targeting the electron-rich aromatic rings and olefinic side-chain structures within the proteins. This can efficiently utilize the alkaline liquid to break down protein molecules within tunicate material, such as exoskeletons, through alkaline hydrolysis, facilitating the removal of proteins. In another example, the alkaline liquid includes at least one of sodium hydroxide and potassium hydroxide. In another example, Non alkali solutions can be used in place of the alkaline liquid and can lead to similar results, including a solution of proteases (e.g., proteinase K), or a concentrated solution of surfactants (for example, sodium dodecyl sulfate). In one non-limiting example, the tunicate material can be contacted with a sodium hydroxide solution (e.g., 2.5M sodium hydroxide solution). In another example, the tunicate material can be contacted with a sodium hydroxide or potassium hydroxide solution having a concentration ranging from about 1M to about 3M. In another example, the tunicate material can be contacted with a sodium hydroxide or potassium hydroxide solution having a concentration of less than 3M.

Contacting the alkaline liquid with the tunicate material can be performed at a temperature of greater than about 30° C. In one example, contacting the alkaline liquid with the tunicate material is performed at a temperature of greater than about 40° C. In another example, contacting the alkaline liquid with the tunicate material is performed at a temperature of greater than about 50° C. Contacting the alkaline liquid with the tunicate material can be performed at a temperature of less than about 100° C. Contacting the alkaline liquid with the tunicate material can be performed at a temperature of less than about 80° C. Contacting the alkaline liquid with the tunicate material can be performed at a temperature of less than about 60° C. Temperatures of the present disclosure (e.g., less than about 100° C.) can be selected to promote removal/breaking down of proteins while reducing overall energy consumption.

The alkaline liquid can be contacted with the tunicate material for a sufficient time to at least partially remove and/or break down proteins, such as one or more hours. In one example, the alkaline liquid can be contacted with the tunicate material for 2 or more hours, 5 or more hours, 7 or more hours, or 10 or more hours. Compared to extraction of cellulose from plant materials, the present process is less reagent and energy-intensive. For example, the present process can utilize a less concentrated alkaline liquid at lower temperatures, increasing the efficiency of the process. Step 110 can be used to fragment proteins. Step 110 can further include rinsing the at least partially deproteinized material to remove residual alkaline liquid and/or dissolved protein fragments.

Referring to Step 120, the at least partially deproteinized material is contacted with a bleaching liquid sufficient to remove one or more non-cellulose materials and to prepare a product material. The bleaching liquid can be capable of removing additional proteins not removed by the alkaline liquid. The bleaching liquid can be an oxidizing liquid. The one or more non-cellulose materials can include at least one of cells, blood vessels, and proteins. In one example, the percentage of proteins in the product material is less than the percentage of proteins in the at least partially deproteinized material. Step 120 can be performed until the at least partially deproteinized material changes color, such as appearing white.

The bleaching liquid can include sodium hypochlorite. In one example, bleaching includes chemical bleaching with one or more of sodium hypochlorite, chlorine, chlorine dioxide, and alkaline peroxide. In one example, contacting the at least partially deproteinized material with the bleaching liquid is performed at a temperature of greater than about 30° C. In another example, contacting the at least partially deproteinized material with the bleaching liquid is performed at a temperature of greater than about 40° C. In another example, contacting the at least partially deproteinized material with the bleaching liquid is performed at a temperature of greater than about 50° C. Contacting the at least partially deproteinized material with the bleaching liquid can be performed at a temperature less than about 90° C. Contacting the at least partially deproteinized material with the bleaching liquid can be performed at a temperature less than about 80° C. Temperatures of the present disclosure (e.g., less than about 90° C.) can be selected to promote removal/breaking down of proteins while reducing overall energy consumption.

The bleaching liquid can be contacted with the at least partially deproteinized material for a sufficient time to remove proteins, such as one or more hours. In one example, the bleaching liquid can be contacted with the at least partially deproteinized material for 2 or more hours, 3 or more hours, 4 or more hours, or 5 or more hours. In some embodiments, method 100 can be performed without Step 120. In some embodiments, method 100 is performed with both Step 110 and Step 120, as Step 120 can ensure that proteins remaining in the at least partially deproteinized material are removed. Step 120 can be used to remove at least 80%, 85%, 90%, or 95% (or values therebetween) of proteins originally in the tunicate material.

Method 100 can further include treating the tunicate material sufficient for at least partial depigmentation of the tunicate material. Treating the tunicate material sufficient for at least partial depigmentation of the tunicate material can be performed prior to Step 110. Treating the tunicate material can be used to extract pigment from the tunicate material, and treatment can utilize a solvent, such as hot water. The hot water treatment can include utilizing a mild sodium hydroxide solution (e.g., 0.5M sodium hydroxide solution). The hot water treatment can include utilizing a sodium hydroxide solution (e.g., less than 1M, less than 1.5M, or less than 2M sodium hydroxide solution). Pigment extraction can be performed at various temperatures, such as temperatures ranging from about 40° C. to about 100° C. In one non-limiting example, the release of pigments increases as the temperature increases. Pigment extraction can be performed at a temperature of greater than 70° C. Pigment extraction can be performed at a temperature of greater than 80° C.

Method 100 can be used to efficiently form structures, such as cellulose- and/or nanocellulose-containing structures, using abundantly available tunicate material with mild treatment steps. For example, compared to extraction of cellulose from plant materials, the present process is less reagent and energy-intensive. For plant materials like wood, these materials often require fibrillation and reassembling, requiring many steps. In one example, method 100 can be performed without a fibrillation step. Accordingly, method 100 can be performed without mechanical crushing and/or shredding. Further, method 100 can be performed using lower temperature conditions and less concentrated reagents. These lower temperatures and less concentrated reagents can improve efficiency of the production process. Further, the product material can be pulled at least 30-50% of its original length without breaking, compared to a few percent, such as under 10%, for plant-based cellulose materials.

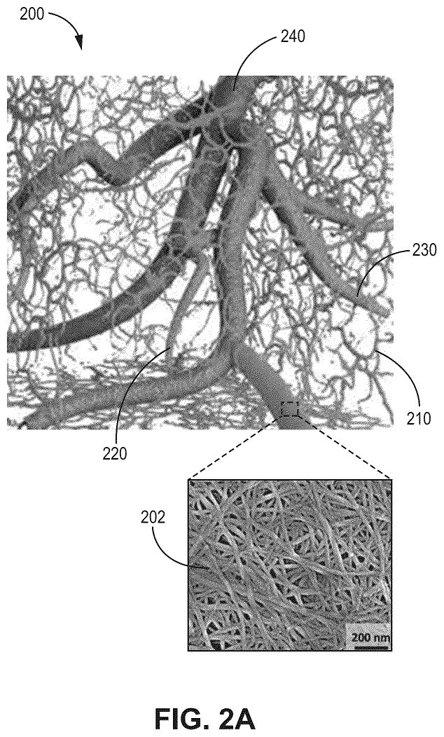

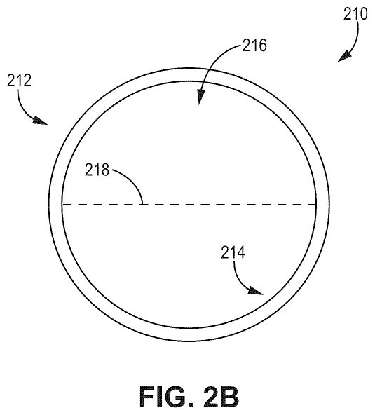

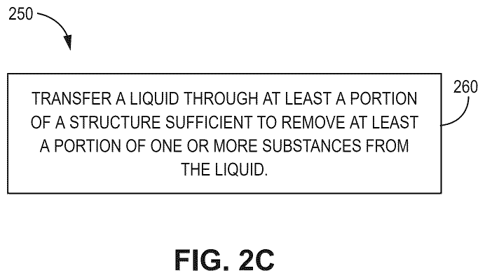

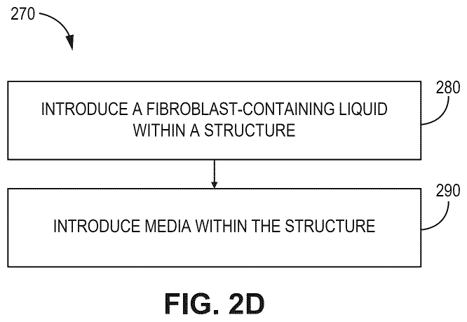

FIG. 2A illustrates a side view of a 3-Dimensional structure including cellulose, according to some embodiments. FIG. 2A shows the structure for illustrative purposes and may not necessarily be drawn to scale. Specifically, FIG. 2A illustrates structure 200, according to some embodiments. Structure 200 can be formed by method 100. Structure 200 can include at least one of first vessels 210, second vessels 220, third vessels 230, and fourth vessels 240. Each of first vessels 210, second vessels 220, third vessels 230, and fourth vessels 240 can include a plurality of similarly sized or shaped vessels. One or more of the first vessels 210, second vessels 220, third vessels 230, and fourth vessels 240 are at least partially formed from at least cellulose 202. Structure 200 can include at least one of first vessels 210, second vessels 220, third vessels 230, and fourth vessels 240 arranged in 3-Dimensions across at least a portion of structure 200.

As shown in FIG. 2A, cellulose 202 can exhibit an entangled orientation. The entangled fibers can be intertwined in a complex manner, such as twisting, looping, and/or intersecting. For example, fibers in an entangled orientation may not run or extend substantially parallel to one another. For example, and in contrast, microbially grown cellulose does not exhibit an entangled orientation of cellulose fibers. Entangled fibers can increase the strength of the material and can promote desired properties for various applications, such as filtration applications. The entangled fibers can also promote efficient stress distribution. Cellulose 202 can include cellulose nanofibers.

FIG. 2B illustrates a cross-sectional view of a vessel of the present disclosure, according to some embodiments. FIG. 2B shows a portion of the vessel for illustrative purposes and may not necessarily be drawn to scale. As shown in FIG. 2B, first vessels 210 can include a substantially tubular structure. First vessels 210 can include outer surface 212, inner surface 214, and first channel 216. First vessels 210 can exhibit a substantially circular cross sectional shape, with an inner diameter 218. Inner diameter 218 can be the diameter of first channel 216. The material forming outer surface 212 and inner surface 214 can be at least partially porous. Importantly, since first vessels 210 can include a substantially tubular structure, first vessels 210 can promote efficient fluid transport through structure 200.

Cellulose 202 can be present in the form of a plurality of cellulose fibers. The plurality of cellulose fibers can be present in the form of small fibers, referred to as cellulose fibrils. In one example, cellulose 202 includes cellulose nanofibers. In one example, the cellulose nanofibers exhibit a mean fibril width ranging from about 10 nm to about 60 nm. In another example, the cellulose nanofibers exhibit a mean fibril width ranging from about 20 nm to about 50 nm. In another example, the cellulose nanofibers exhibit a mean fibril width of greater than about 10 nm. In another example, the cellulose nanofibers exhibit a mean fibril width of less than about 45 nm. Generally, the length of the cellulose nanofibers is greater than the mean fibril width. In one example, structure 200 is substantially free of proteins. In another example, structure 200 is completely free of proteins.

Structure 200 can include a plurality of channels. Cellulose in structure 200 can at least partially form the walls of the channel(s) (e.g., walls between outer surface 212 and inner surface 214). The plurality of channels can include at least one of first channels and second channels. In one example, first vessels 210 can include first channels, such as first channel 216. Accordingly, first vessels 210 are capable of holding fluid(s) and/or allowing the transfer of fluid(s) therethrough. In one example, the first channels exhibit a first mean diameter of between 1 μm and 100 μm. The first mean diameter can be length of inner diameter 218. The diameters of the vessels of the present disclosure can promote efficient fluid flow therethrough, while enabling filtration of a target substance. Structure 200 can be used for various filtration applications. For example, structure 200 can be used as a filtration membrane to filter a substance from a liquid, such as filtering bacterium from a liquid such as water. The bacterium can be present in a suspension of water.

In one example, the first channels exhibit a first mean diameter of between 10 μm and 80 μm. In another example, the first channels exhibit a first mean diameter of between 20 μm and 60 μm. The first channels can exhibit a first mean diameter of greater than 20 μm. The first channels can exhibit a first mean diameter of greater than 30 μm. The first channels can exhibit a first mean diameter of less than 100 μm. The first channels can exhibit a first mean diameter of less than 80 μm. In comparison, methods of 3D printing are only able to produce geometries with larger dimensions, such as greater than 100 μm. Importantly, first channels can include nanocellulosic vessels having resolutions below 100 μm—useful for various applications such as microfluidics and filtration.

Second vessels 220 can include one or more similar features to first vessels 210, such as being substantially tubular. Second vessels 220 can include second channels. Second channels can include one or more features of the first channels. Accordingly, second vessels 220 are capable of holding fluid(s) and/or allowing the transfer of fluid(s) therethrough. The second channels can exhibit a second mean diameter of greater than the first mean diameter. In one example, the second channels exhibit a second mean diameter of between 80 μm and 250 μm. In another example, the second channels exhibit a second mean diameter of between 100 μm and 200 μm. In another example, the second channels exhibit a second mean diameter of between 100 μm and 150 μm. The second channels can exhibit a second mean diameter of greater than 80 μm. The second channels can exhibit a second mean diameter of greater than 100 μm. The second channels can exhibit a second mean diameter of less than 220 μm. The second channels can exhibit a second mean diameter of less than 200 μm. At least one of the first channels can be connected to at least one of the second channels sufficient for perfusion of a liquid into the first channels and the second channels.

Third vessels 230 can include one or more similar features to first vessels 210, such as being substantially tubular. Third vessels 230 can include third channels. Accordingly, the plurality of channels can further include third channels. The third channels can exhibit a third mean diameter of greater than the second mean diameter. In one example, the third channels exhibit a third mean diameter of between 80 μm and 250 μm. In another example, the third channels exhibit a third mean diameter of between 100 μm and 200 μm. In another example, the third channels exhibit a third mean diameter of between 100 μm and 150 μm. The third channels can exhibit a third mean diameter of greater than 80 μm. The third channels can exhibit a third mean diameter of greater than 100 μm. The third channels can exhibit a third mean diameter of less than 220 μm. The third channels can exhibit a third mean diameter of less than 200 μm.

Fourth vessels 240 can include one or more similar features to first vessels 210, such as being substantially tubular. Fourth vessels 240 can include fourth channels. Accordingly, the plurality of channels can further include fourth channels. The fourth channels can exhibit a fourth mean diameter of greater than the third mean diameter. In another example, the fourth channels exhibit a fourth mean diameter of between 200 μm and 600 μm. In another example, the fourth channels exhibit a fourth mean diameter of between 300 μm and 600 μm. The fourth channels can exhibit a fourth mean diameter of greater than 300 μm. The fourth channels can exhibit a fourth mean diameter of greater than 400 μm. The fourth channels can exhibit a fourth mean diameter of less than 700 μm. The fourth channels can exhibit a fourth mean diameter of less than 550 μm.

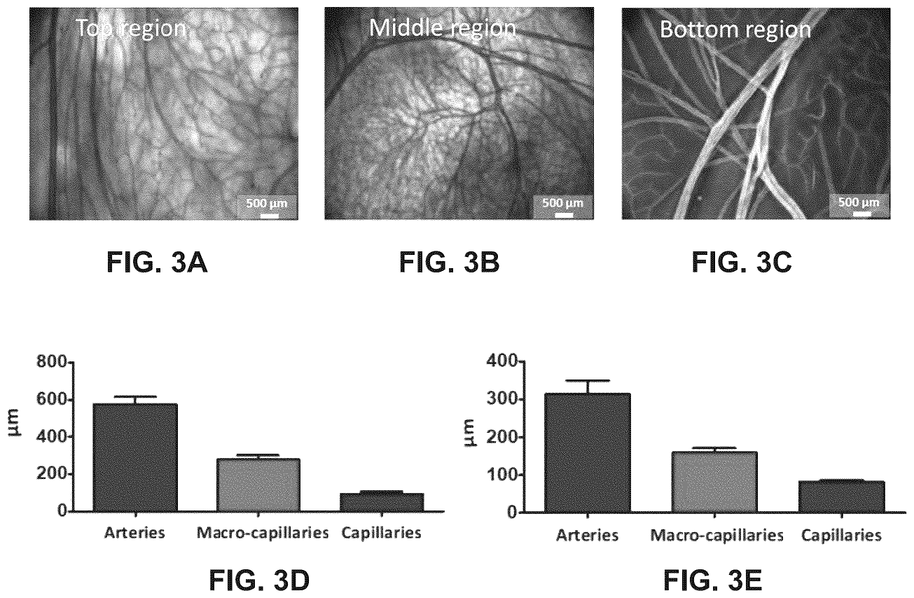

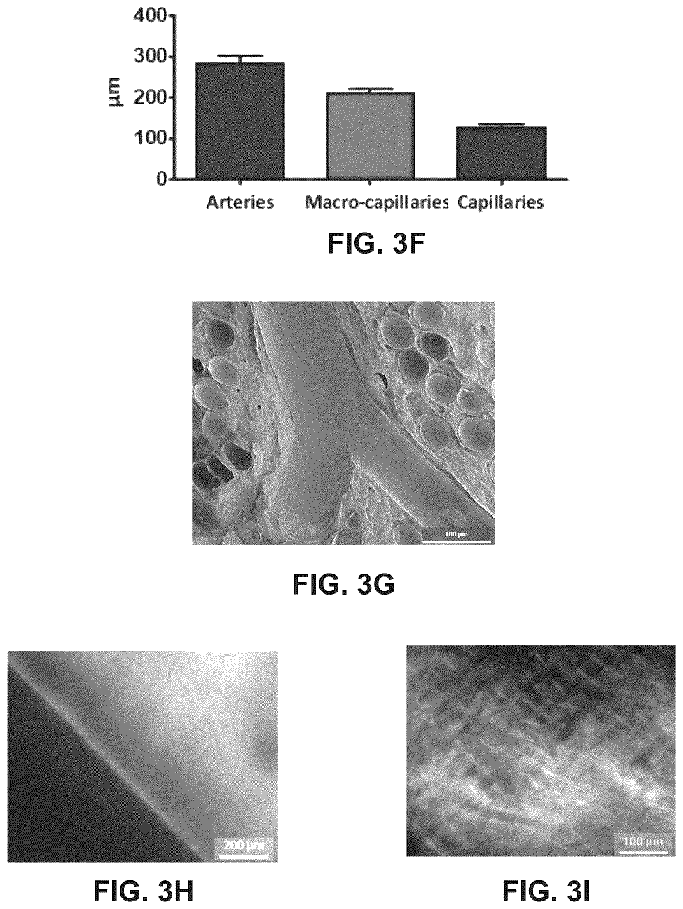

Structure 200 can include a plurality of capsules. For example, FIG. 3G illustrates capsules, and FIG. 3G is discussed further herein. The plurality of capsules can be substantially spherical. The plurality of capsules can exhibit a substantially annular cross-sectional shape. The plurality of capsules can include an internal volume (e.g., hollow). The plurality of capsules can have an average diameter ranging from about 10 μm to about 100 μm. In one example, the plurality of capsules exhibits an average diameter ranging from about 30 μm to about 80 μm. In another example, the plurality of capsules exhibits an average diameter ranging from about 40 μm to about 60 μm. In yet another example, the plurality of capsules exhibits an average diameter of about 50 μm.

Importantly, since structure 200 can include at least one of first vessels 210, second vessels 220, third vessels 230, and fourth vessels 240, structure 200 can be efficiently utilized for applications utilizing the vessel(s) for fluid transport. Accordingly, structure 200 can be used for various microfluidics applications, filtration, and for recellularization. Fluid can flow (e.g., diffuse) through the vessels of structure 200 at a substantially constant flow rate across the length of the structure, even with a plurality of different diameter vessels distributed throughout structure 200. Thus, in one example, as vessels form sub-branches, the sum of the area of the sub-branches can equal the area of the initial supply vessel. In some embodiments, an ultrafiltration or microfiltration membrane includes structure 200. In one example, membranes of the present disclosure can be used for filtering substances with a size ranging from about 0.1 to about 10 μm. In another example, membranes of the present disclosure can be used for filtering substances with a size ranging from about 0.1 to about 5 μm.

Methods of the present disclosure include liquid filtration utilizing the structures of the present disclosure. FIG. 2C illustrates a method for membrane filtration, according to some embodiments. Method 250 includes at least Step 260. Referring to Step 260, a liquid is transferred through at least a portion of the structure sufficient to remove at least a portion of one or more substances from the liquid. Example liquids include solvents, such as water. Example substances include particles or bacteria. These particles or bacteria can exhibit various sizes, such as a size ranging from about 0.1 to about 10 μm. In another example, these particles or bacteria can exhibit various sizes, such as a size ranging from about 0.1 to about 5 μm. For example, bacteria can have an average size of about 2 μm. At least in part due to the range of vessels (e.g., ranging from 10 μm to 500 μm) arranged hierarchically across the structure, such as at least first vessels 210 and second vessels 220, the structure can be used as a membrane to efficiently remove one or more substances from a fluid using desired flow rates.

Structures of the present disclosure can be utilized for various microfluidics applications. For example, the structures of the present disclosure can also be used as microfluidic perfusion materials and/or for recellularization. Accordingly, these structures can be used for flowing fluids through the structure. In one example, during perfusion, the structure demonstrates uniform diffusion of liquid throughout the channels/vessels. The perfusate can flow into Y-shaped branches of the microfluidic channels. In another example, during perfusion, the structure reveals substantially consistent diffusion of liquid throughout the channels/vessels in a pressure-dependent manner. The microfluidics perfusion material can be sufficient for perfusion of a liquid into a plurality of channels.

FIG. 2D illustrates a method for recellularization, according to some embodiments. Accordingly, the structures of the present disclosure, such as structure 200, can be utilized for cell growth. For example, the structure can include a nanocellulosic network including entangled cellulose fibers. In one example, the structure does not negatively impact cellular functions and exhibits cytocompatibility. Cells can be introduced into and/or on the structure, and nutrients can be transferred to the cells. Method 270 includes at least one of Step 280 and Step 290. Step 290 can be performed subsequent to Step 280.

Referring to Step 280, a fibroblast-containing liquid is introduced within a structure of the present disclosure. The fibroblast-containing liquid can be introduced within at least a portion of the structure and can flow through one or more vessels of the structure. For example, the structure can be perfused (e.g., passage of the liquid through one or more vessels of the structure from one portion of the structure to another portion of the structure) with a fibroblast suspension. Fibroblast cells can be perfused through the structure sufficient for the fibroblast cells to be transferred throughout one or more of the vessels of the structure. The cells can be included in a suspension and contacted with at least a portion of the structure to introduce the cells on/within the structure.

Fibroblasts can include cells for secreting collagen proteins. To prepare the cells for introduction with the structure, these cells can be cultured in Dulbecco's modified eagle medium (DMEM) media with fatal bovine serum (FBS) until reaching desired confluence. In one example, the cells include human fibroblast cells. In one non-limiting example, human fibroblast cell lines can be cultured in DMEM supplemented with FBS. Culturing may also include using penicillin-streptomycin and/or carbon dioxide. In one example, culturing can be completed until reaching 80-90% confluence. The cells can then be detached (e.g., using trypsin-EDTA), centrifuged (e.g., 1000 rpm for about 5 minutes), and resuspended in fresh media prior to introduction in the structure. A syringe can be utilized for perfusion. Step 280 may further include incubation. The incubation can include using carbon dioxide and gentle agitation to promote cell adhesion to the structure. Incubation can utilize carbon dioxide and can be performed for 12 or more, 16 or more, or 20 or more hours. For example, incubation can be performed at about 37° C. using carbon dioxide. In one example, after a plurality of cells have attached to the structure, the structure can be contacted with DMEM and FBS for culture.

The structure can be sterilized via immersion in ethanol (e.g., 70% for 30 minutes), followed by rinsing with sterile phosphate-buffered saline (PBS). Air injection can address water droplet accumulation, blockages, and occlusion in the structure. A vacuum can be created, and air can be injected via a syringe pump to clear blockages, promoting unobstructed fluid flow.

Referring to Step 290, media is introduced within the structure. Media can be introduced to at least a portion within and/or on the structure, e.g., perfused through one or more vessels of the structure. The media can include one or more cell nutrients. For example, Step 290 can include injecting a media with serum, optionally using a syringe pump. For example, Dulbecco's modified eagle medium (DMEM) media with serum can be injected into the structure. DMEM with fetal bovine serum (FBS, e.g., 10%) can be pumped (e.g., 1 mL/min) using a syringe and needle. The perfused media can flow through the vessels of the structure, delivering nutrients to cells attached to one or more surfaces of the structure.

Method 250 can be sufficient for active fibroblast proliferation, optionally showing cytoskeletal organization and cell growth along the micro-vessel network of the structure. Since the structure can include a plurality of vessels capable of transferring fluid(s), fluids are efficiently transported to the portion of the structure including the cells. In one example, cells exhibit high viability since the structure does not induce cytotoxicity in fibroblasts. The cellulose nanonetwork in the structure can efficiently store and provide nutrients, thereby promoting sustained cell growth and integration within the structure. The structure can be used for microfluidic systems and tissue engineering applications, at least in part due to the structure's capability to support cell proliferation and migration.

The structures of the present disclosure can be formed from tunicate material and can exhibit a range of vessels (e.g., ranging from 10 μm to 500 μm) arranged hierarchically across the structure. Multiple scales including this architecture promote efficient use of the formed materials for various applications, such as membrane filtration, microfluidics, and recellularization. The tunicate materials of the present disclosure can also be used for forming packaging materials and for producing dyes. Importantly, the structures of the present disclosure can be formed without using fibrillation, reducing energy consumption and promoting the preparation of structures having multi-scaled vessels with unique cellulose fiber lengths, diameters, and orientations.

The following Examples are intended to illustrate the above invention and should not be construed as to narrow its scope. It should be understood that numerous variations and modifications may be made while remaining within the scope of the invention.

### Example 1—Tunicates

Tunicates (e.g., Phallusia nigra) were collected from marine vessels and platforms located at Marina Island in Abu Dhabi, UAE, within the Persian Gulf region. Since tunicates can include ascidians, the examples may refer to tunicates as “ascidians”. Within the Examples, sodium hydroxide pellets (≥98.0%) and chlorine bleach solution (5.25% hypochlorite in water) were also utilized. After sample collection, the tunicates were thoroughly washed with water to remove external contaminants. Then, internal digestive organs were removed using forceps, and the outer cellulose rich tunics were separated and thoroughly washed with deionized water at room temperature (e.g., about 20° C.).

Botryllus schlosseri (invasive gold star ascidians) were also tested and used to make constructs of the present disclosure. These species can include a microcapillary network in the cellulosic hydrogel system interconnected within a zooid system. The microcapillaries can be included in the inner region of the cellulose hydrogel system. For example, invasive golden star tunicates, Botryllus schlosseri, can exhibit dense colonization on a ship hull and port structures. Small colonies of these species can be collected from the ship hull, exhibiting green and honey-colored variants. These species can include common cloaca, serving as the exhalant siphon, and the inhalant siphon of a zooid within a zooid system.

Tunics include two components: pigments and an extracellular matrix densely packed with protein-cellulose fibril aggregates, collectively forming a sturdy, leathery exoskeleton. The tunic can include two layers: a dense outer layer (exoskeleton) and a loosely arranged inner layer bordering the epidermal cells. In solitary tunicates like Phallusia nigra, the thickness of the tunic can extend to 8-10 mm. The native tunicate exoskeleton includes randomly arranged cellulose fibers with a relatively lower protein content. However, the proportion of cellulose to proteins varies significantly between the outer cuticular layer and the inner fibrous layer. Cellulose in tunicates is synthesized by epidermal cells, while the associated proteins can be produced by specific tunic cells, such as granular and globular cells for fiber-associated and cuticular proteins, respectively.

FIG. 3A illustrates a microscopic image of one region displaying a branched vascular network in raw tunicates (e.g., prior to treatment), according to some embodiments. FIG. 3A illustrates the top region of the raw tunicate. FIG. 3B illustrates a microscopic image of one region displaying a branched vascular network in raw tunicates, according to some embodiments. FIG. 3B illustrates the middle region of the raw tunicate. FIG. 3C illustrates a microscopic image of one region displaying a branched vascular network in raw tunicates, according to some embodiments. FIG. 3C illustrates the bottom region of the raw tunicate. The natural structure of the tunicate (Phallusia nigra) facilitates the transport of nutrients through microvasculature. Tunicates include branched hearts, which cyclically pump hemolymph in one direction before reversing periodically.

A multimodal capillary size was observed, where size distributions were following multiple distinct scales. Accordingly, four distinct size ranges were included: large capillaries at or above 500 μm, which were less common, and three sub-types of branches herein categorized as arteries (diameter: 280-650 μm), macro-capillaries (diameter: 120-240 μm), and capillaries (diameter: 50-100 μm). The diameter was quantitatively assessed at the bottom, middle, and top regions of the tunic. FIG. 3D illustrates vascular analysis with means and standard deviation values for the region illustrated in FIG. 3A. FIG. 3E illustrates vascular analysis with means and standard deviation values for the region illustrated in FIG. 3B. FIG. 3F illustrates vascular analysis with means and standard deviation values for the region illustrated in FIG. 3C. Diameters were substantially larger in the top region than in the middle and bottom regions that had similar sizes. For example, smaller capillaries were most abundant in the middle region.

FIG. 3G illustrates a scanning electron microscope (SEM) image of a portion of a processed tunicate, according to some embodiments. Scanning electron microscopy (SEM) observation of the tunicate revealed both the cellular structures of tunicates and the interconnected vascular channels. These micro vasculatures were included within the cellulose nanofiber construct, encircled by rounded hollow cells, where the cellulose is part of the extracellular matrix surrounding and connecting individual cells that are themselves encapsulated in a single sheet layer of nanocellulose.

FIG. 3H illustrates a polarized light microscopic image of a portion of a raw tunicate, according to some embodiments. FIG. 3I illustrates a polarized light microscopic image of a portion of a raw tunicate, according to some embodiments. When observed between cross-polarizers, the cellulosic nanonetworks appeared bright white, as associated with the high crystallinity of tunicate cellulose, which is highly birefringent. Individual cell edges can be visualized under cross-polarizers showing a sharp white, highlighting the relative densities of nanocellulose in the capsule surrounding individual cells and in the extracellular matrix. For the long-range order of cellulose using a retardation plate between cross-polarizers, a slight change in order was observed around the vasculature, indicating a different orientation when compared to the rest of the nanonetwork.

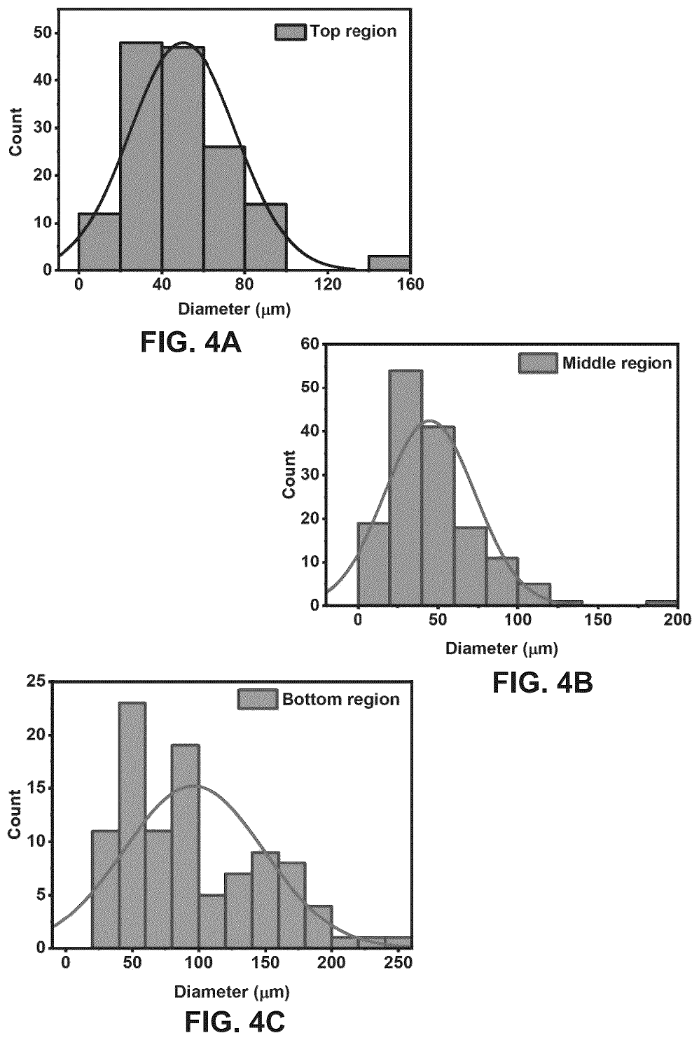

FIG. 4A illustrates a histogram illustrating the average diameter measurements in the region of FIG. 3A, according to some embodiments. As shown in FIG. 4A, the diameter ranged from about 10 μm to about 160 μm, with the mean diameter ranging from about 20 μm to about 60 μm. FIG. 4B illustrates a histogram illustrating the average diameter measurements in the region of FIG. 3B, according to some embodiments. As shown in FIG. 4B, the diameter ranged from about 10 μm to about 200 μm, with the mean diameter ranging from about 25 μm to about 75 μm. FIG. 4C illustrates a histogram illustrating the average diameter measurements in the region of FIG. 3C, according to some embodiments. As shown in FIG. 4C, the diameter ranged from about 25 μm to about 275 μm, with the mean diameter ranging from about 75 μm to about 150 μm.

### Example 2—3-D Structure Including Cellulose

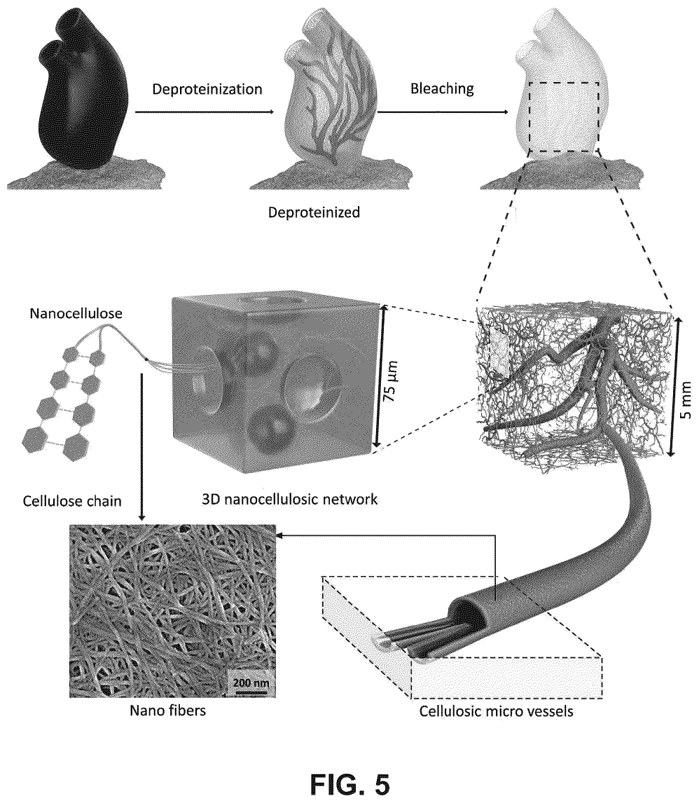

FIG. 5 illustrates an example method for preparing a cellulose network, according to some embodiments. To isolate the cellulose network while preserving the cellulose content, a mild chemical deproteinization method was employed (2.5 M sodium hydroxide (NaOH), 50° C. and bleaching with 0.05% sodium hypochlorite (NaOCl). Compared to traditional plant-based cellulose production methods, which typically involve high-pressure sodium sulfide or 4 M NaOH at 90° C. followed by high-concentration bleaching, the present method can be performed at temperatures below 90° C. with concentrations of NaOH below 4M. The obtained cellulosic nanonetwork is highly pure compared to wood sources, as residual hemicelluloses in wood processing are particularly challenging to remove from sources such as wood. In one example, the structure's (of the present disclosure) coherent behavior is not substantially affected by the removal of non-cellulosic, which could conventionally lead to fibrillation. This highlights the structural integrity of the prepared materials even after extensive purification treatments.

The tunicate exoskeletons were deproteinized using a 2.5 M sodium hydroxide solution at 50° C. for 12 hours (solution changes were performed at four-hour intervals). This allows hydroxyl (HO·) and superoxide anion (O2·−) radicals generated from NaOH to target the electron-rich aromatic rings and olefinic side-chain structures within the proteins. Multiple rinses with deionized water were conducted to eliminate chemicals and separate the deproteinized tunics. The deproteinized material was then bleached with hypochlorite solution (0.05% in DI water, diluted from a 2.5% solution) for 6 hours at 50° C. (solution changes were made in 2-hour intervals) to obtain the desired product material, followed by further washing with deionized water to remove the protein content from the product material.

Tunicate tunics measured approximately 7 cm in height, 5 cm in diameter, and with a wall thickness of 0.4 cm. During deproteinization, the NaOH solution diffused quickly throughout the tissue material via the micropores, pits and capillary-like features of tunicate tissues. The natural dark blue color of the tunicate tunic tissue gradually diminished and eventually turned yellow. The deproteinization process yielded 59.66% deproteinized tunicate, with the losses including natural dye and proteinaceous components. Following deproteinization, the tunicate tunic underwent hypochlorite bleaching, turning the material completely white/translucent with a 54.72% yield from the raw biomass weight. Even with significant air drying, the product materials were able to regain their original dimensions upon rewetting.

Swelling behavior, evident in the thickness swelling test, highlights that samples were able to recover close to their original weight after dehydration. Results showed nearly 95% shape recovery of tunicate membranes after 24 hours of water immersion, prior to removal of noncellulosics, reflecting outstanding water responsiveness.

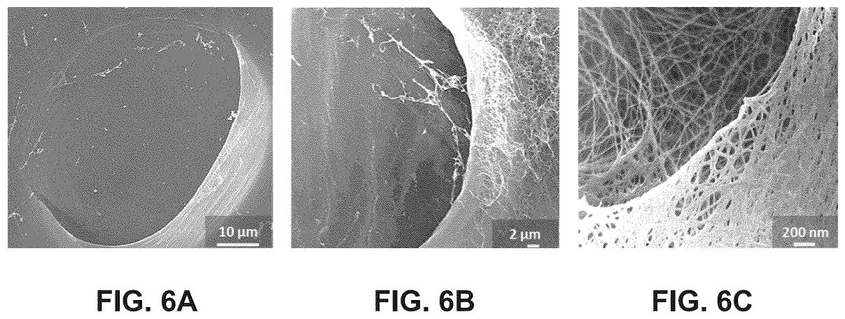

FIG. 6A illustrates an SEM image of the raw tunicate, including protein-cellulose complex, nanofibers, and cells, according to some embodiments. FIG. 6B illustrates an SEM image of the product material after deproteinization, according to some embodiments. FIG. 6C illustrates an SEM image of the product material after bleaching, according to some embodiments. SEM micrographs highlighted the microstructural changes of the tunicate during the chemical deproteinization process. Over the deproteinization and bleaching process, the tunicate cells and the protein contents gradually decreased, enabling the isolation of the cellulosic nanonetwork, with the interconnected vascular networks and the multi-scaled nanofibrils structures remaining well preserved (FIG. 6C). The relatively unoriented arrangement of cellulose nanofibers is quite atypical of what is observed in plants and more closely resembles those obtained from microbial cellulose (FIG. 6C).

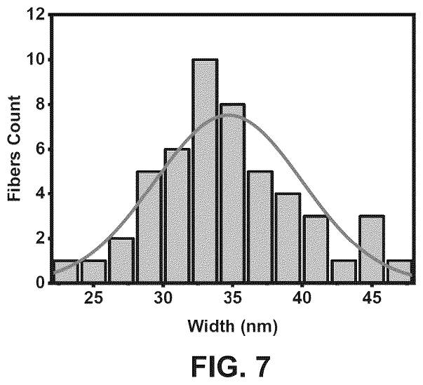

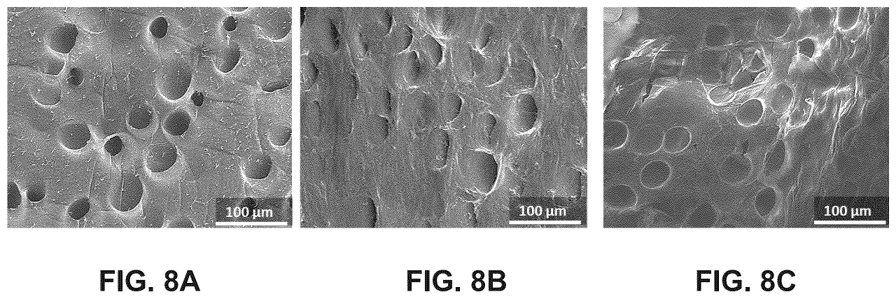

FIG. 7 illustrates a histogram showing the width distribution of cellulose fibers in the product material, according to some embodiments. As is the case with microbial nanofibers, tunicate nanofibers were found to vary in width substantially, with an average diameter of 47.8±22.5 nm. However, the fact that the fibers are entangled rather than cross-linked, distinguishes the nanofiber network from microbially grown cellulose (see FIG. 2A). In particular, the apparent absence of nodes is noticeable, wherein the fibrils can be primarily individualized. FIG. 8A illustrates an SEM image of a portion of a raw tunicate, according to some embodiments. FIG. 8B illustrates an SEM image of a portion of a deproteinized tunicate, according to some embodiments. FIG. 8C illustrates an SEM image of a portion of a product material, according to some embodiments. As shown, a plurality of channels is shown in the product material.

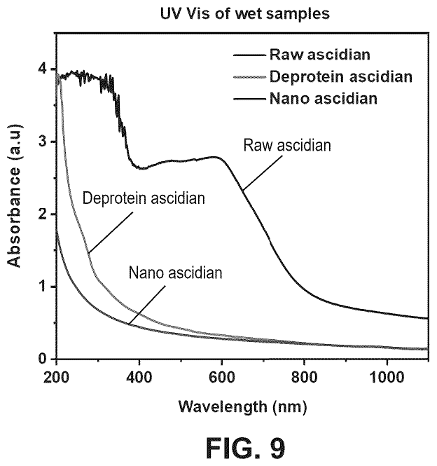

FIG. 9 illustrates ultraviolet-visible (UV-Vis) spectra comparing raw tunicate, deproteinized tunicate, and product material, according to some embodiments. The example figures may also refer to the tunicate as “ascidian”. Figures referring to “nano-ascidian” or the like refer to the product material after deproteinization and bleaching. Chemical composition analysis highlighted the presence of protein residues in the deproteinized tunicate tunic cellulosic materials. UV-Vis spectra of raw, deproteinized, and product material samples in the range of 200 and 1000 nm confirmed the presence of residuals in the deproteinized samples and complete removal for the product material samples.

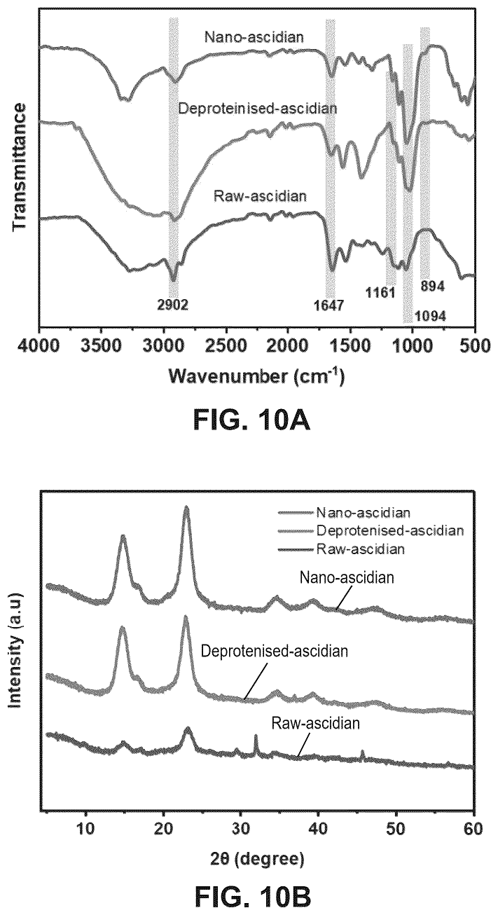

FIG. 10A illustrates Fourier Transform Infrared Spectroscopy (FTIR) analysis of raw tunicate, deproteinized tunicate, and product material, according to some embodiments. The spectrum analysis revealed cellulose-associated characteristic peaks. This includes specific adsorption bands at 2902 cm⁻¹ (related to C—H symmetric stretching), 1161 cm⁻¹ (associated with C—O—C glucose skeletal stretching), and 1049 cm⁻¹ (indicative of C—O—C pyranose stretching), as documented in previous references. Additionally, a discernible peak corresponding to the anomeric (C1) vibration of the β (1-4) glycosidic linkages in cellulose was clearly observed at 894 cm⁻¹. These clearly distinguishable peaks are characteristics of pure cellulose. Raman spectroscopy measurements support the FTIR results. Notably, these spectra prominently featured several sharp peaks, indicating the presence of both cellulose and protein. Among these peaks were those at 380 cm⁻¹ and 1096 cm⁻¹.

FIG. 10B illustrates x-ray crystallography (XRD) analysis showing the presence of cellulose nanofibers in raw tunicate, deproteinized tunicate, and product material, according to some embodiments. For example, x-ray diffraction (XRD) highlighted that all three sample sources exhibit consistent cellulose-I patterns, featuring prominent crystalline peaks at 14.8°, 17°, and 23°, corresponding to the (11 [symbol] ), (110), and (200) crystal planes, respectively. These peaks are indicative of the highly crystalline nature of the cellulose Iβ structure in the tunicate samples, with a low fraction of amorphous segments. Additionally, weaker signals associated with the 004-cellulose reflection were observed, notably occurring at 34.2°2θ, consistent with previous studies.

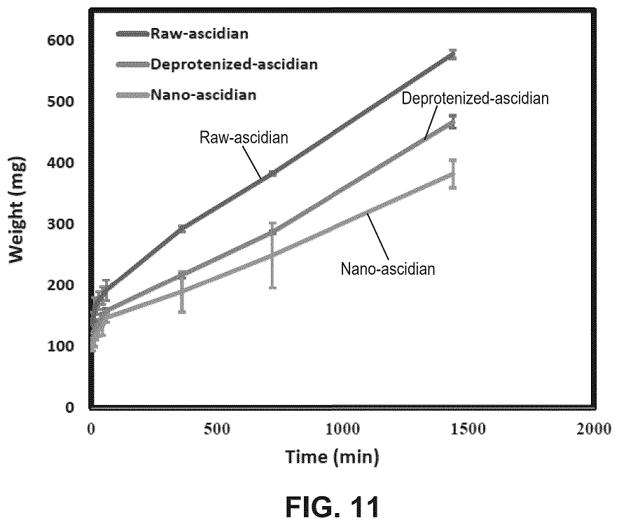

FIG. 11 illustrates the water uptake efficiency of raw tunicate, deproteinized tunicate, and product material, according to some embodiments. As shown, similar to raw tunicates, the product material exhibited excellent water uptake efficiency throughout the 1500 minute test period. The weight of the product material increased from nearly 100 mg to nearly 400 mg within the 1500 minute test period.

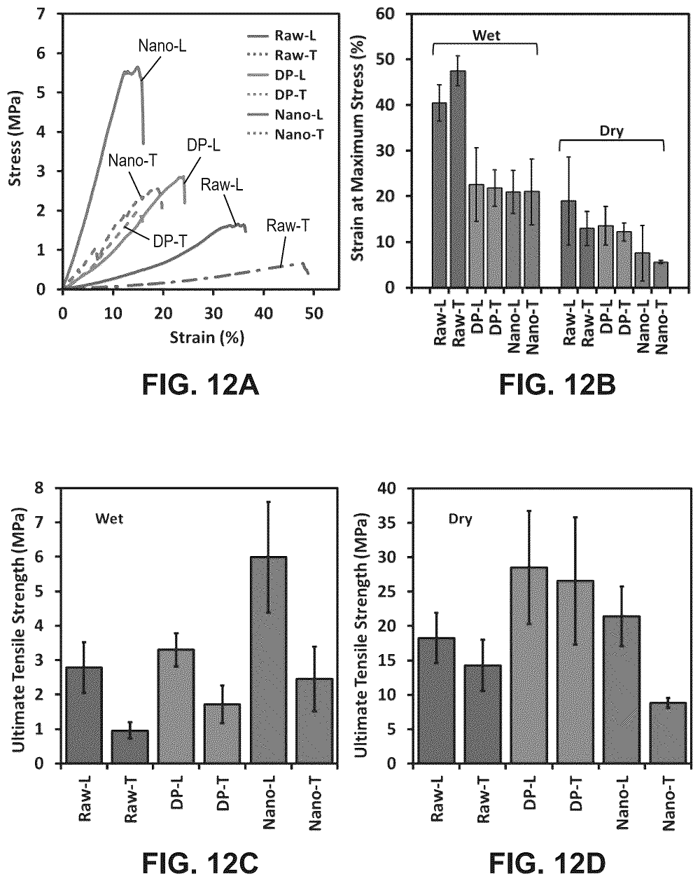

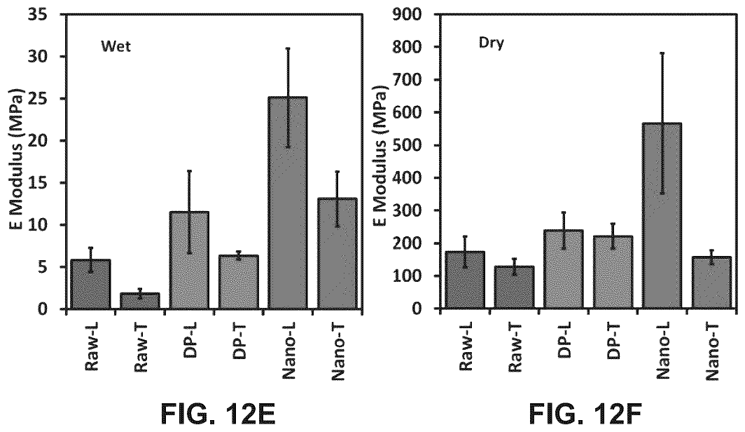

FIG. 12A illustrates tensile stress-strain response of wet samples, according to some embodiments. The samples were compressed by approximately five fold across the thickness of the tunic during sample cutting In the illustrations, L refers to “longitudinal” and T stands for “transverse” orientations. Raw refers to the raw tunicate material, DP refers to the at least partially deproteinized material, and Nano refers to the product material. The crystalline structure and multi-scale structures of tunicate's cellulose nanofibrils can play a role in determining the mechanical properties. Particularly, the load transfer and dispersion of stresses throughout the material can be associated with cellular ultrastructure and vessels. The tensile mechanical properties of tunicate samples in raw and treated states (deproteinized and product material) were evaluated under wet and dry conditions, both longitudinally (along long axis) and transversely. Representative stress-strain curves are shown in FIG. 12A for samples in the wet state, indicating distinct mechanical behaviors depending on the extent of treatment and the orientation of the samples relative to the strain.

FIG. 12B illustrates strain at failure (ductility) of various samples, according to some embodiments. FIG. 12C illustrates tensile stress at failure (ultimate tensile strength) of various samples in the wet state, according to some embodiments. FIG. 12D illustrates tensile stress at failure (ultimate tensile strength) of various samples in the dry state, according to some embodiments. FIG. 12E illustrates elastic modulus of various samples in the wet state, according to some embodiments. FIG. 12F illustrates elastic modulus of various samples in the dry state, according to some embodiments. Typical dried nanocellulosic materials have a strain at failure of a few percent.

The raw tunicates showed a strain at break of over 47% and of up to 19% in the wet and dried states, respectively. Surprisingly, dried deproteinized samples had a strain of up to 13.5% with higher strength—can be due to the residual proteins or reaction reagents (e.g. residual alkali) forming dynamic non-covalent cross-links with the nanocellulose during the drying process. These networks can act as sites for energy dissipation within the material, leading to an improvement in mechanical properties. For example, the effect of such networks is not as pronounced in the wet (never-dried) samples, where the trend showed a consistent reduction in ductility with each non-cellulosics removal step. In general, wet samples withstood higher strains than dried ones before breaking. Moreover, samples tested in the longitudinal direction (suffix—L) exhibited improved properties compared to their transversely tested (suffix—T) counterparts. This anisotropy is likely due to the structural orientation of cellulose fibers, which have better alignment parallel to the longitudinal direction in correspondence with the cellular and vascular formations within the tunicate tissue.

The vasculature mostly extends from the base to the top of the tunicates, thereby enhancing load distribution, mechanical strength, and strain resistance in that direction. For example, in the wet state, the product material exhibited the highest wet tensile strength with a 115% improvement compared to raw samples in the longitudinal orientation, reaching up to 6 MPa. This can be a result of the elasticity of the material, reducing the chance for defects to lead to early fracture. However, in the dry state (FIG. 12D), deproteinized samples showed an absolute tensile strength of up to 28.5 MPa in the longitudinal orientation. This corresponds to a 56% improvement over raw tunicates. This suggests that the protein/nanocellulose or residuals/nanocellulose crosslinking during drying also contributed to the prevention of early fracturing, unlike in the bleached samples, which can be more protein depleted and can be more brittle after cellulose-cellulose interactions occur post-drying. Accordingly substantial enhancement in the elastic modulus was observed in the dried (FIG. 12F) product material samples at 567 MPa.

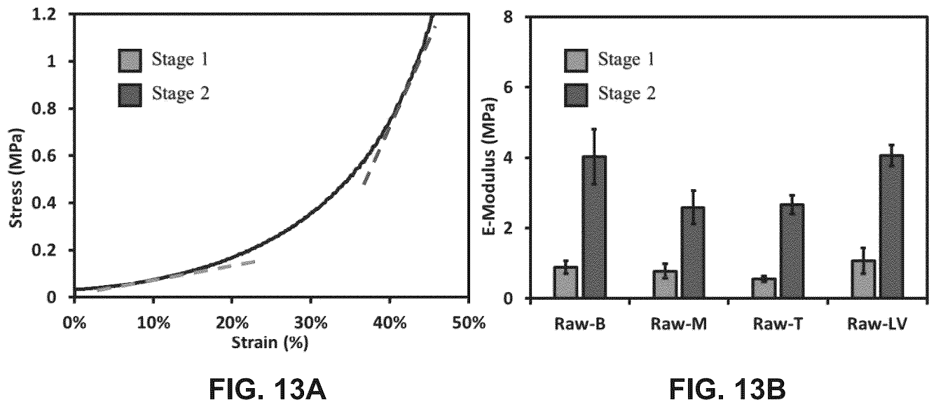

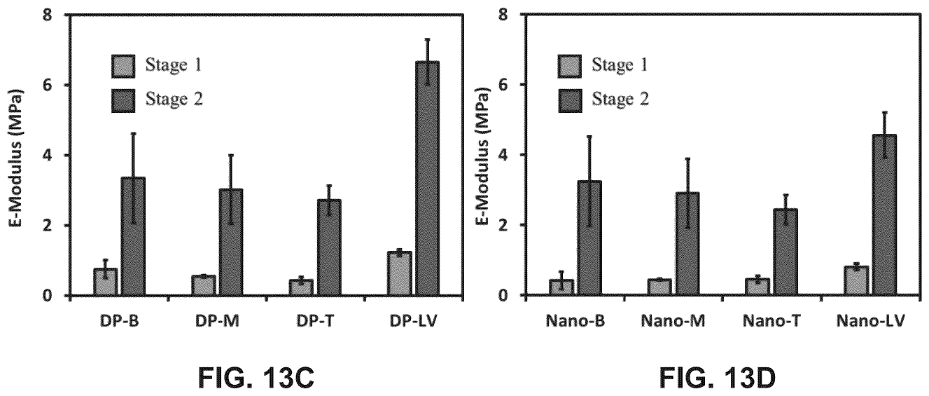

FIG. 13A illustrates compression stress-strain curves of product material from the top region, according to some embodiments. Compression tests were done on samples from vein-rich tissue and low vein regions (top, middle, and bottom from high to low) to further understand the impact of vascular arrangement and internal cellular structure on the mechanical properties of tunicates. A typical response of cellular materials was observed, where the cellular structure and the presence of vein cavities dominated in the initial stages of compression. During compression, the tissue seems to undergo two stages, each identified by distinct E-moduli.

FIG. 13B illustrates e-modulus for raw tissue from (Raw-B), middle (Raw-M), top (Raw-T), and low-vein regions (Raw-LV), according to some embodiments. FIG. 13C illustrates e-modulus for deproteinized product from the middle region (DP-B), middle (DP-M), Top (DP-T), and low vein regions (DP-LV), according to some embodiments. FIG. 13D illustrates e-modulus for product material from the bottom region (Nano-B), middle (Nano-M), Top (Nano-T), and low vein regions (Nano-LV), according to some embodiments. The first stage, where the initial energy of compression packs the porous cellular structure into solid sheets, results in a lower and similar E-modulus for samples across different treatments (˜0.5 MPa for samples from vein-rich regions, and ˜1 MPa for samples from low-vein regions). This is followed by a second stage with an abrupt increase in the E-modulus as further compression of the packed material occurs.

The slopes “pre-packing” are similar for samples, with a slight decrease from bottom to top in the vein-rich tunicate tissue, reflecting the size distribution of the vascular structure where bigger cavities result in lower stiffness. The similarity of the E-moduli at this stage reveals the dominance of the cells/vasculature compaction over the nano-structural/molecular nature of the material itself. However, in the second stage, differences between the sampling locations (bottom, mid, or top) become more pronounced as this stage is more influenced by the fiber nanonetwork. In both stages, the low-vein region consistently exhibited higher stiffness in samples.

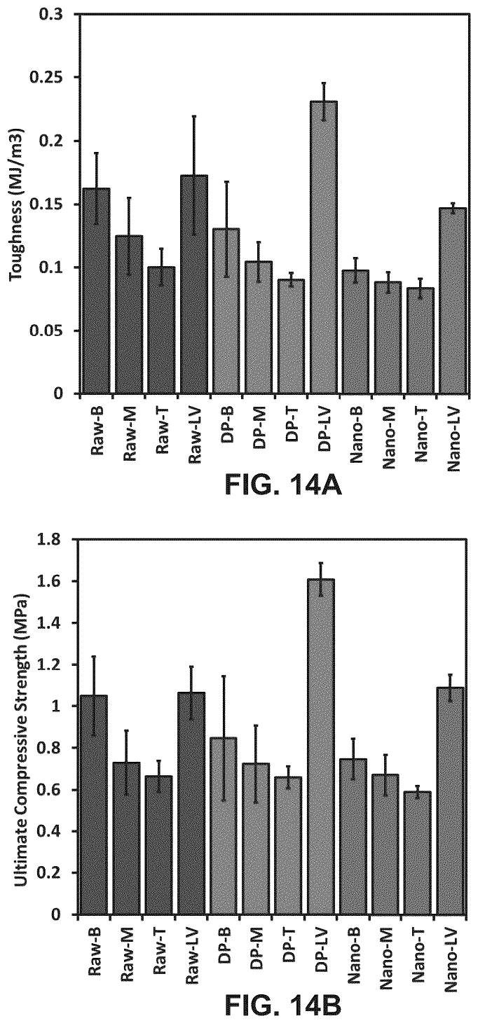

FIG. 14A illustrates toughness performance for Raw (Raw), Deproteinized (DP), and product (Nano) materials in the Bottom (B), Middle (M), Top (T), and Low-Vein (LV) regions, according to some embodiments. For vein-rich samples, the tunicate body exhibited increasing toughness from top to bottom, confirming the trend observed in the samples'stiffness. Treatment resulted in a slight decrease in the samples'toughness and ultimate compressive strength at 50% strain. In one example, this trend was not observed for samples from low-vein areas, which displayed the highest toughness and ultimate compressive strength. FIG. 14B illustrates ultimate compressive strength for Raw (Raw), Deproteinized (DP), and product (Nano) materials in the Bottom (B), Middle (M), Top (T), and Low-Vein (LV) regions, according to some embodiments. This is associated with the more continuous nature of the nanonetwork in the absence of vasculature, with enhanced mechanics observed in the low vein region of the deproteinized sample, reaching a toughness of 231 GJ/m³ and an ultimate compressive strength of 1.6 MPa, higher than both nano and raw samples. This suggests that the presence of residual proteins may have a similar effect on compressive mechanical strength enhancement as observed in tensile mode.

Human vascular networks dynamically respond to angiogenic signals, resulting in the formation of complex capillary beds with intricate branching patterns across multiple planes and random paths. Replicating these characteristics is rather challenging with modern 3D printing and microfluidic techniques, often producing simple geometries (e.g., regular tubes) with larger dimensions (>100 μm). There is a natural similarity between tunicate and mammalian vascularization, both capable of supporting fluid flow and transporting oxygen, nutrients, and other biomolecules. Utilizing the product materials of the present disclosure as microfluidic platforms offers a significant advantage due to the unique vessels. Herein, well-defined vessels with a diameter of 50 μm are present in the tissues obtained.

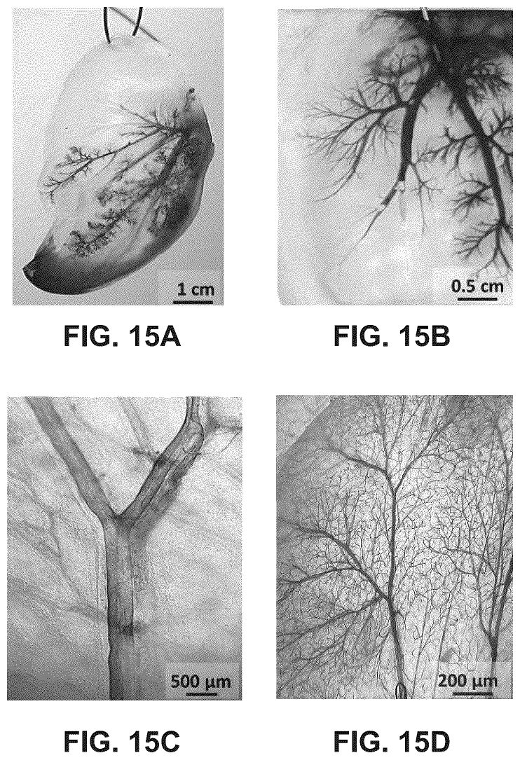

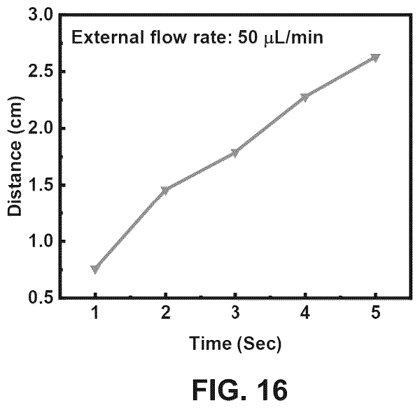

FIG. 15A illustrates perfusion through product material, according to some embodiments. FIG. 15B illustrates perfusion through product material, according to some embodiments. Methylene blue diffused throughout the vasculature. Consistent perfusion and minor diffusion across the vasculature were observed. FIG. 15C illustrates perfusion through product material, according to some embodiments. The perfusate also flowed into and through the smaller branches of the tunicate capillaries. FIG. 15D illustrates perfusion through product material, according to some embodiments. FIG. 16 illustrates perfusion distance of methylene blue through the product material at constant applied fluid pressure, according to some embodiments. Surprisingly, methylene blue diffusion length at a constant flow rate resulted in a linear perfusion distance, suggesting that the total cross-sectional area remained constant, which would be consistent with a fractal network of capillaries. The fluid traveled 2.7 cm in 5 seconds at a flow rate of 10 μL/s. Overall, the product material has the potential for control transport of fluids in three dimensions.

### Example 3—Pigment From Tunicates

Fresh raw tunicate exoskeleton carefully sectioned into square-shaped pieces measuring approximately 4×4×1.5 mm (length, width, thickness) was prepared. These pieces were immersed in 100 mL of 0.5 M NaOH solution in a beaker and subjected to temperatures ranging from 40 to 100° C. for 6 hours under magnetic stirring at 500 rpm. The characteristic absorption spectra from the pigment solutions were evaluated using UV-Vis spectroscopy. Interactions between extracted pigments and cellulose were investigated by immersing cellulose strips (Whatmann paper, Grade 52) in the obtained pigments for 30 minutes, followed by drying at room conditions.

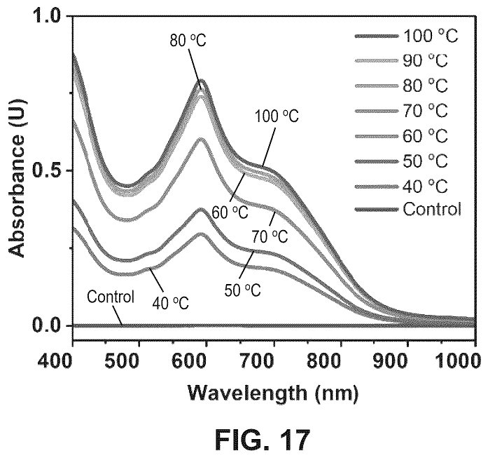

FIG. 17 illustrates UV analysis for the extraction of bioink at various temperatures, according to some embodiments. Raw tunicates were placed at temperatures ranging from 40 to 100° C. to investigate its effect on pigment extraction. The release of pigments increased with elevated temperatures. The extracted pigments were then immersed in Whatman filter paper (pure cellulose I) to assess color changes, revealing discernible variations in response to temperature fluctuations. Tunicate-derived blue pigment shows uniform color and good fastness on cellulose filter papers. UV-vis analysis demonstrated that the absorbance increased with rising temperature, indicating that the quantity of extracted dyes increased, while there was no apparent variation in the types of dye extracted. The dye, as a co-product, can potentially be explored for its applications in food coloring and textile dye production.

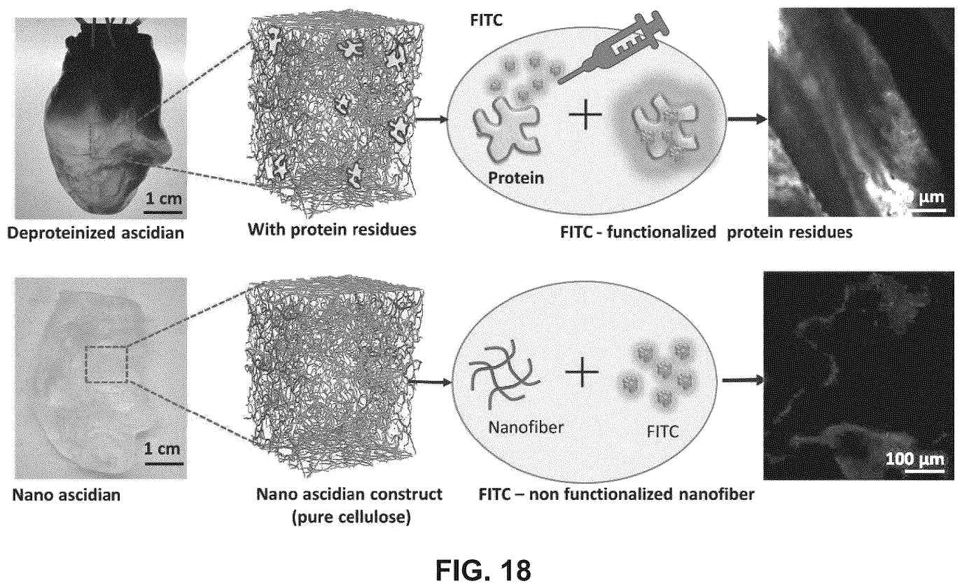

FIG. 18 illustrates a comparison of the reactivity based on protein chemistry of a tunicate and the product material of the present disclosure, according to some embodiments. In its natural state the tissues can include proteins and cellulose, a feature that is not present in plants. The presence of protein offers an opportunity for biofunctionalization. To highlight this, both deproteinized and product material were treated with fluorescein isothiocyanate and analyzed using fluorescence microscopy. As shown, the presence of the protein was detected through fluorescence emission by fluorescein-labeled deproteinized samples. On the other hand, the absence of fluorescence emission observed in product material samples was attributed to the elimination and complete removal of protein content, highlighting cellulosic materials which can exhibit with a protein-dependent chemistry.

### Example 4—Membrane

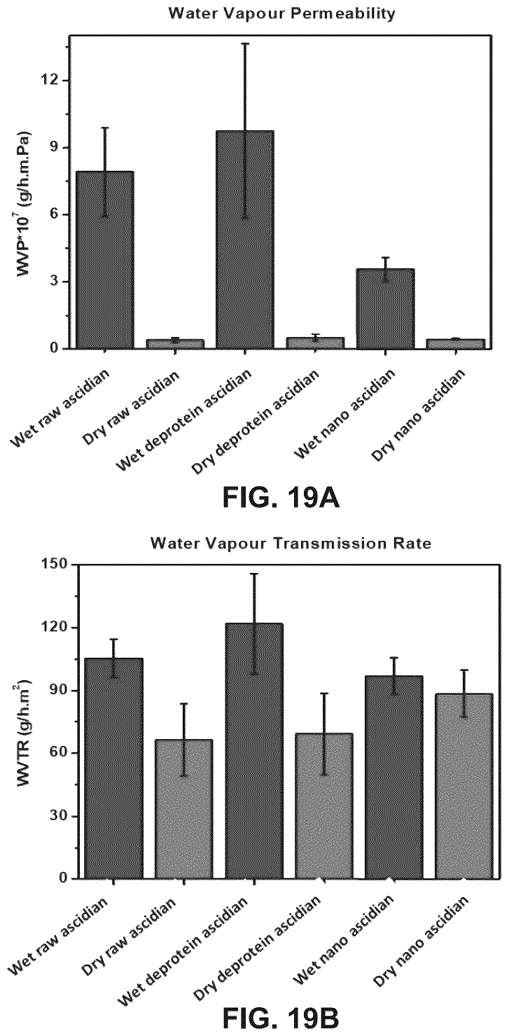

The water vapor permeability (WVP) and water vapor transmission rate (WVTR) of the membranes were also assessed to understand their potential applications in various fields. FIG. 19A illustrates water vapor permeability (WVP) of raw tunicate, deproteinized tunicate, and product material, according to some embodiments. FIG. 19B illustrates water vapor transmission rate (WVTR) of raw tunicate, deproteinized tunicate, and product material, according to some embodiments. As shown, the dry state of raw, deproteinized, and product material samples indicated significant differences in their water vapor transmission properties.

The water vapor permeability (WVP) of the membranes was assessed in triplicate for all samples based on slight modifications to ASTM E96/E96M-16 standards. The WVP values for the wet raw tunicate, deproteinized, and product samples were measured as 7.903×10-7 g/h·m·Pa, 9.745×10-7 g/h·m·Pa, and 3.543×10-7 g/h·m·Pa, respectively. Similarly, the WVP values for the dry raw, deproteinized, and product counterparts were recorded as 3.748×10-7 g/h·m·Pa, 4.836×10-7 g/h·m·Pa, and 4.293×10-7 g/h·m·Pa, respectively. In dry product material, permeability values were reduced compared to wet samples due to the formation of a denser 3D nano-fibril network, which promotes a higher number of hydrogen bonds and increases the density of the cellulose nanofiber. The water vapor transmission rate (WVTR) was measured gravimetrically over 24 hours at 23° C. In both wet and dry product material membranes, different permeability values were observed.

Specifically, the WVTR increased in dry product material, possibly due to water vapor transmission through the nano cellulosic network after the removal of pigments and dense cellular and protein matrix within the polymeric cellulose network. Compared to wet membranes (wet raw tunicate: 105.3759 g/h·m²; deproteinized: 121.8066 g/h·m²; and product material: 96.76621 g/h·m²), the dry product materials exhibited drastically reduced water vapor permeability. The WVTR values for dry raw (66.20846/h·m²), deproteinized (69.11866 g/h·m²), and product material (88.27794/h·m²) membranes, respectively.

Lastly, a multi-scaled product material membrane of the present disclosure was assessed by evaluating its potential to filter bacteria and for water vapor permeability. Escherichia coli was used as the model bacterium, given its cylindrical morphology with an approximate diameter of 2 μm. Results indicate that the membranes efficiently isolates microbes under a constant flux.

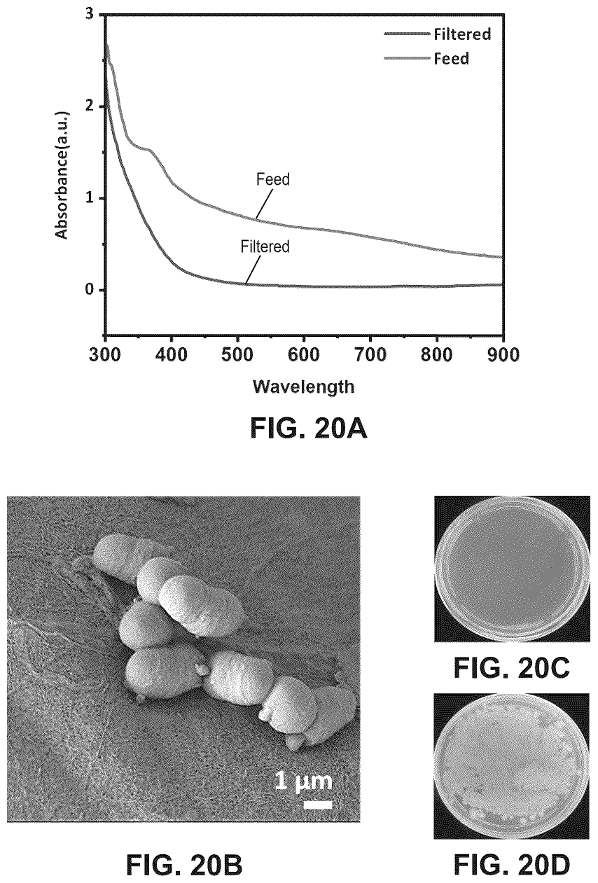

FIG. 20A illustrates UV-Vis analysis of bacterial solutions before and after filtration, according to some embodiments. FIG. 20B illustrates an SEM image showing bacteria on a membrane after filtration, according to some embodiments. FIG. 20C illustrates near zero bacterial growth in the solution post-filtration after overnight culture of the filtrate according to some embodiments. FIG. 20D illustrates the observation of bacterial growth after overnight culturing prior to filtration, according to some embodiments. The ability of the product material to filter bacteria from water was investigated using Escherichia coli, a cylindrical bacterium with a long-axis dimension of approximately 2 μm, as the model bacterium. UV analysis of filtration with product material membrane filters demonstrated nearly complete rejection of the bacteria. Bacterial counts using a hemacytometer estimated a rejection rate of at least 99%. The liquid collected before and after filtration was cultured overnight, showing near zero bacterial growth in the filtered solution. Scanning electron microscopy (SEM) revealed bacterial accumulation on the product material membranes, indicating effective filtration by the nanoporous product material membranes. The trapped bacteria were distributed non-uniformly, with bacteria predominantly observed on the surface area where the solution was infused.

### Example 5—Recellularization

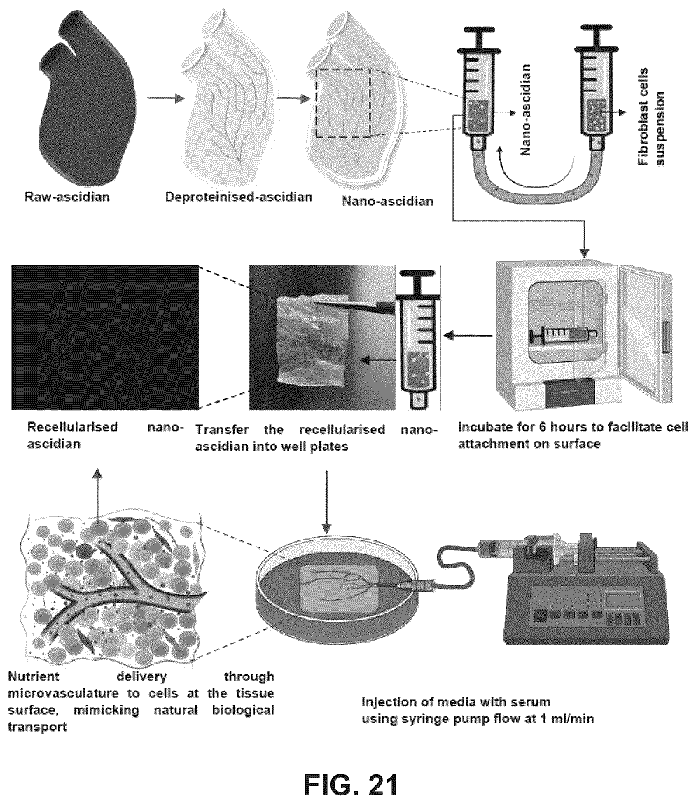

FIG. 21 illustrates an example method for recellularization, according to some embodiments. Human fibroblast cell lines were cultured in DMEM supplemented with 10% fatal bovine serum (FBS) and 1% penicillin-streptomycin at 37° C. with 5% CO₂ until reaching 80-90% confluence. For cell harvesting, the cells were detached using 0.25% trypsin-EDTA, neutralized with medium, centrifuged at 1000 rpm for 5 minutes, and resuspended in fresh medium. To seed cells, 200,000 cells per structure were introduced onto preconditioned 3D product material structures, which were placed in a 24-well plate and incubated for 24 hours at 37° C. and 5% CO₂.

The structures were sterilized via immersion in 70% ethanol for 30 minutes, followed by rinsing with sterile phosphate-buffered saline (PBS). To address water droplet accumulation, blockages, and occlusion in the product material microfluidic system, an air injection technique was employed. A syringe connected to 1.3 mm Tygon tubing was attached to the structure through a 0.3 mm needle inserted into the arterial channels. A vacuum was created by pulling back the plunger, then air was injected via a syringe pump to clear blockages, ensuring unobstructed fluid flow.

To seed mammalian cells onto the product material structures, a dual-syringe system was used. Two syringes were connected via elastic tubing; the structure was placed in one syringe and 5 mL of cell suspension in the other. The cell suspension was injected into the structure-containing syringe. After 6 hours of incubation to ensure cell attachment, the structure was transferred into a 6-well plate containing DMEM with 10% FBS for culture. A perfusion system was set up to supply media continuously through the structure's microvasculature. DMEM with 10% FBS was pumped at 1 mL/min using a syringe connected to a needle inserted into the structure's heart junction. The process was monitored for consistent flow, with adjustments made to clear air bubbles or blockages.

To assess biocompatibility, a live/dead assay was performed. A staining solution containing 10 μL of Calcein AM and 20 μL of Ethidium Homodimer-1 in 5 mL of PBS was introduced into the microfluidic channels. The structures were incubated at 37° C. for 30 minutes, protected from light, and then washed 2-3 times with PBS. Confocal microscopy was used to capture images, with Calcein AM visualized at 488 nm/515 nm (green) and Ethidium Homodimer-1 at 528 nm/617 nm (red). Cell viability was assessed across multiple fields of view. For further cell tracking, a Cell Light staining solution (30 μL/mL) was added to the structures, incubated at room temperature, and visualized under fluorescence microscopy to distinguish live cells.

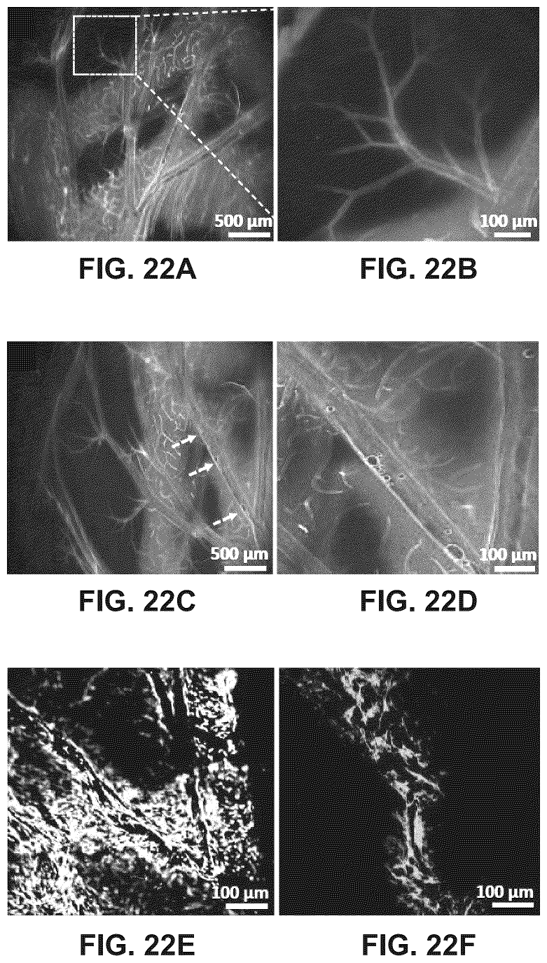

FIG. 22A illustrates a fluorescence image following perfusion, according to some embodiments. FIG. 22B illustrates an enlarged view of a portion of FIG. 22A, according to some embodiments. Perfusion of product material structures with Rhodamine dye, administered via a syringe pump at 1 mL/min with minimal fluid loss, resulted in uniform dye distribution and deep penetration into the structure. FIG. 22C illustrates a fluorescence image showing liquid bubbles, according to some embodiments. FIG. 22D illustrates a fluorescence image showing liquid bubbles, according to some embodiments. This uniformity indicates that the structures effectively facilitate fluid flow, simulating vascular networks and supporting efficient nutrient transport and delivery.

FIG. 22E illustrates a fluorescence image showing y-shaped channels and a network of microfluidics, according to some embodiments. FIG. 22F illustrates a fluorescence image showing cell attachment, growth and proliferation along microvasculature, according to some embodiments. Active fibroblast proliferation along the product material cellulosic network fibers further confirms efficient nutrient supply through the structure's microfluidic channels. This is corroborated by nutrient distribution patterns (FIG. 22E) and the resultant cell proliferation along the structure's microvasculature (FIG. 22F). Over time, fibroblasts were observed attaching, spreading, and aligning along the product material structure.

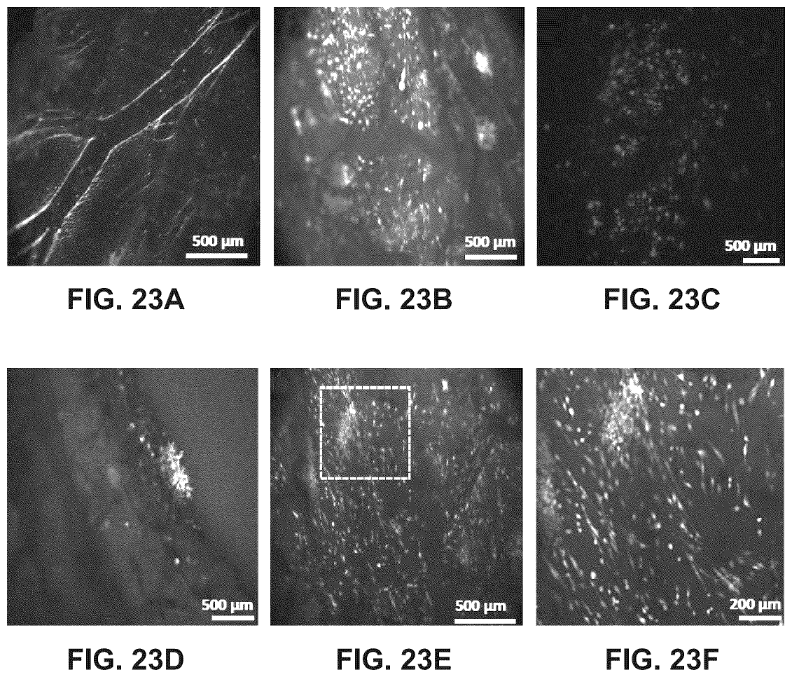

FIG. 23A illustrates a control image showing vasculature without cells, according to some embodiments. FIG. 23B illustrates an imaging showing that recellularized structures preserve patency and perfusion capabilities after bleaching, according to some embodiments. By day 3, the structure was fully covered with a dense sheet of cells, indicating substantial cell proliferation and migration.

FIG. 23C illustrates 4′,6-diamidino-2-phenylindole (DAPI) staining showing the presence of fibroblast cells on the structure, according to some embodiments. Further biological analysis of the product material structures focused on the organization of the actin cytoskeleton and the distribution of cell nuclei. FIG. 23C illustrates intricate networks of actin filaments and cell nuclei after 7 days of 3D culture, revealing complete coverage of the structure by cells. FIG. 23D illustrates fractures in the vascular channels with cell accumulation at these sites, according to some embodiments. The images also confirm efficient perfusion of CellLight Actin-GFP solution through the structure capillaries, demonstrating successful nutrient absorption by the cells. The organized actin cytoskeleton highlights the structure's ability to support robust cell attachment and integration. Furthermore, the high viability of cells at observed time points indicates that the deproteinized and bleached product material structure does not induce cytotoxicity in fibroblasts.

FIG. 23E illustrates healthy cell attachment and proliferation, with cells growing near the main channel, first-order branches, and network areas after three days, according to some embodiments. FIG. 23F illustrates an enlarged view of a portion of FIG. 23E, according to some embodiments. After one week of culture, even under static conditions, the 3D nanocellulosic fibers within the product material structure effectively stored and supplied adequate nutrients to sustain continuous cellular growth. The cell growth phase advanced from the gradual coverage of the fiber surface to complete infilling with cell mass. This progression demonstrates that the interconnected 3D nanocellulosic network can efficiently store and provide nutrients, thereby promoting sustained cell growth and integration within the structure.

### Discussion of Possible Embodiments

The following are non-exclusive descriptions of possible embodiments of the present invention.

According to one aspect, a method for preparing a cellulose nanonetwork includes (a) contacting an alkaline liquid with tunicate material sufficient to form an at least partially deproteinized material; and (b) contacting the at least partially deproteinized material with a bleaching liquid sufficient to remove one or more non-cellulose materials and to prepare a product material.

The method of the preceding paragraph can optionally include, additionally and/or alternatively any one or more of the following features/steps, configurations, and/or additional components.

For example, the method may include (c) treating the tunicate material sufficient for at least partial depigmentation of the tunicate material.

For example, step (c) can be performed prior to step (a).

For example, treating the tunicate material can include contacting the tunicate material with water at a temperature of greater than about 40° C.

For example, the alkaline liquid can include at least one of sodium hydroxide and potassium hydroxide.

For example, the method may include contacting the alkaline liquid with the tunicate material is performed at a temperature of greater than about 40° C.

For example, the bleaching liquid includes sodium hypochlorite.

For example, the method may include contacting the at least partially deproteinized material with the bleaching liquid is performed at a temperature of greater than about 40° C.

For example, the tunicate material includes tissue from at least one of Phallusia nigra and Botryllus schlosseri.

For example, the product material can include a network having cellulose nanofibrils exhibiting an entangled orientation.

For example, the cellulose fibrils can exhibit a mean fibril width ranging from about 20 nm to about 50 nm.

For example, the product material can be substantially free of protein.

According to another aspect, a cellulose-containing material includes a 3-Dimensional structure including: cellulose nanofibers; and a plurality of channels, the plurality of channels including first channels and second channels, wherein the first channels exhibit a first mean diameter of between 10 μm and 80 μm, and the second channels exhibit a second mean diameter greater than first mean diameter, wherein the 3-Dimensional structure is substantially free of proteins.

The material of the preceding paragraph can optionally include, additionally and/or alternatively any one or more of the following features, configurations, and/or additional components.

For example, the cellulose fibers can exhibit an entangled orientation.

For example, the cellulose fibers can exhibit a mean fibril width ranging from about 20 nm to about 50 nm.

For example, the 3-Dimensional structure can include a plurality of capsules exhibiting an average diameter ranging from about 40 μm to about 60 μm.

For example, the second mean diameter can range from about 80 μm to about 200 μm.

For example, the plurality of channels can further includes third channels, wherein the third channels exhibit a third mean diameter of greater than 200 μm.

For example, at least one of the first channels can be connected to at least one of the second channels.

For example, at least one of the first channels can be connected to at least one of the second channels sufficient for perfusion of a liquid into the first channels and the second channels, and wherein the cellulose-containing material is a microfluidics perfusion material.

According to another aspect, a microfiltration membrane includes cellulose fibers; and a plurality of channels, the plurality of channels including first channels and second channels, wherein the first channels exhibit a first mean diameter of between 10 μm and 80 μm, and the second channels exhibit a second mean diameter greater than the first mean diameter, wherein at least a portion of the cellulose fibers exhibit an entangled orientation.

The membrane of the preceding paragraph can optionally include, additionally and/or alternatively any one or more of the following features, configurations, and/or additional components.

For example, the cellulose fibers can exhibit a mean fibril width ranging from about 20 nm to about 50 nm.

According to another aspect, a method for membrane filtration includes transferring a liquid through at least a portion of a structure sufficient to remove at least a portion of one or more substances from the liquid.

The method of the preceding paragraph can optionally include, additionally and/or alternatively any one or more of the following features/steps, configurations, and/or additional components.

For example, the structure includes a structure of the present disclosure.

For example, the liquid can include a solvent.

For example, the liquid can include water.

For example, the one or more substances can include bacteria.

For example, the one or more substances can include bacteria having an average size ranging from about 0.1 to about 10 μm.

For example, the one or more substances can include particles having an average size ranging from about 0.1 to about 10 μm.

According to another aspect, a method for recellularization includes introducing a fibroblast-containing liquid within a structure and introducing media within the structure.

The method of the preceding paragraph can optionally include, additionally and/or alternatively any one or more of the following features/steps, configurations, and/or additional components.

For example, the structure includes a structure of the present disclosure.

For example, the fibroblast-containing liquid can include a plurality of cells.

For example, the media can include one or more nutrients.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof.

Therefore, it is intended that the invention not be limited to the particular embodiment(s) disclosed, but that the invention will include all embodiments falling within the scope of the appended claims.

1. A method for preparing a cellulose nanonetwork, the method comprising:
(a) contacting an alkaline liquid with tunicate material sufficient to form an at least partially deproteinized material; and
(b) contacting the at least partially deproteinized material with a bleaching liquid sufficient to remove one or more non-cellulose materials and to prepare a product material.

2. The method of claim 1 further comprising (c) treating the tunicate material sufficient for at least partial depigmentation of the tunicate material.

3. The method of claim 2, wherein step (c) is performed prior to step (a).

4. The method of claim 2, wherein treating the tunicate material includes contacting the tunicate material with water at a temperature of greater than about 40° C.

5. The method of claim 1, wherein the alkaline liquid includes at least one of sodium hydroxide and potassium hydroxide.

6. The method of claim 1, wherein contacting the alkaline liquid with the tunicate material is performed at a temperature of greater than about 40° C.

7. The method of claim 1, wherein the bleaching liquid includes sodium hypochlorite.

8. The method of claim 1, wherein contacting the at least partially deproteinized material with the bleaching liquid is performed at a temperature of greater than about 40° C.

9. The method of claim 1, wherein the tunicate material includes tissue from at least one of Phallusia nigra and Botryllus schlosseri.

10. The method of claim 1, wherein the product material includes a network having cellulose nanofibrils exhibiting an entangled orientation.

11. The method of claim 10, wherein the cellulose fibrils exhibit a mean fibril width ranging from about 20 nm to about 50 nm.

12. The method of claim 10, wherein the product material is substantially free of protein.

13. A cellulose-containing material, the cellulose-containing material comprising:
a 3-Dimensional structure including:
cellulose nanofibers; and
a plurality of channels, the plurality of channels including first channels and second channels, wherein the first channels exhibit a first mean diameter of between 10 μm and 80 μm, and the second channels exhibit a second mean diameter greater than the first mean diameter,
wherein the 3-Dimensional structure is substantially free of proteins.

14. The cellulose-containing material of claim 13, wherein the cellulose fibers exhibit an entangled orientation.

15. The cellulose-containing material of claim 13, wherein the cellulose fibers exhibit a mean fibril width ranging from about 20 nm to about 50 nm, and wherein the 3-Dimensional structure includes a plurality of capsules exhibiting an average diameter ranging from about 40 μm to about 60 μm.

16. The cellulose-containing material of claim 13, wherein the second mean diameter ranges from about 80 μm to about 200 μm.

17. The cellulose-containing material of claim 16, wherein the plurality of channels further includes third channels, wherein the third channels exhibit a third mean diameter of greater than 200 μm.

18. The cellulose-containing material of claim 13, wherein at least one of the first channels is connected to at least one of the second channels sufficient for perfusion of a liquid into the first channels and the second channels, and wherein the cellulose-containing material is a microfluidics perfusion material.

19. A microfiltration membrane, the microfiltration membrane comprising:
cellulose fibers; and
a plurality of channels, the plurality of channels including first channels and second channels, wherein the first channels exhibit a first mean diameter of between 10 μm and 80 μm, and the second channels exhibit a second mean diameter greater than the first mean diameter,
wherein at least a portion of the cellulose fibers exhibit an entangled orientation.

20. The microfiltration membrane of claim 19, wherein the cellulose fibers exhibit a mean fibril width ranging from about 20 nm to about 50 nm.
